(19) United States
(12) Patent Application Publication
(10) Pub. No.: US 2025/0280468 A1
(43) Pub. Date: Sep. 4, 2025

(54) Multicast and Broadcast Services Enhancements in New Radio

(71) Applicant: Apple Inc., Cupertino, CA (US)

(72) Inventors: Fangli Xu, Beijing (CN); Yuqin Chen, Beijing (CN); Haijing Hu, Los Gatos, CA (US); Dawei Zhang, Saratoga, CA (US); Chunhai Yao, Beijing (CN); Peng Cheng, Beijing (CN)

(21) Appl. No.: 18/859,001

(22) PCT Filed: Jun. 13, 2022
(86) PCT No.: PCT/CN2022/098341

§ 371 Date: Oct. 22, 2024

(51) Int. Cl. H04W 76/40; H04W 4/06; H04W 72/0457; H04W 76/28

(52) U.S. Cl. CPC H04W 76/40; H04W 4/06; H04W 72/0457; H04W 76/28

(57) ABSTRACT

A wireless device can receive, on a first component carrier (CC), a radio resource control (RRC) configuration message from a serving base station (BS). The RRC configuration message can comprise multicast and broadcast services (MBS) scheduling information or configuration information. The wireless device can further receive a transmission from a MBS BS comprising additional MBS information on the first CC. The wireless device can determine a collision between a unicast transmission and a broadcast transmission and transmit an indication of interest to the MBS BS. The wireless device can receive, from the MBS BS and on a second CC a RRC reconfiguration message comprising adjusted scheduling information or configuration information corresponding to the unicast transmission. The wireless device can receive the broadcast transmission from the MBS BS and the unicast transmission from the serving BS based at least in part on the adjusted scheduling information or configuration information.

### PRIORITY INFORMATION

This application n is a national stage entry of PCT Application No. PCT/CN2022/098341, entitled “Multicast and Broadcast Services Enhancements in New Radio,” filed Jun. 13, 2022, which is hereby incorporated by reference in its entirety as though fully and completely set forth herein. The claims in the instant application are different than those of the parent application or other related applications. The Applicant therefore rescinds any disclaimer of claim scope made in the parent application or any predecessor application in relation to the instant application. The Examiner is therefore advised that any such previous disclaimer and the cited references that it was made to avoid, may need to be revisited. Further, any disclaimer made in the instant application should not be read into or against the parent application or other related applications.

### FIELD

The present application relates to wireless communications, and more particularly to systems, apparatuses, and methods for multicast and broadcast services enhancements in a wireless communication system.

### DESCRIPTION OF THE RELATED ART

Wireless communication systems are rapidly growing in usage. In recent years, wireless devices such as smart phones and tablet computers have become increasingly sophisticated. In addition to supporting telephone calls, many mobile devices (i.e., user equipment devices or UEs) now provide access to the internet, email, text messaging, and navigation using the global positioning system (GPS), and are capable of operating sophisticated applications that utilize these functionalities. Additionally, there exist numerous different wireless communication technologies and standards. Some examples of wireless communication standards include LTE, LTE Advanced (LTE-A), NR, HSPA, IEEE 802.11 (WLAN or Wi-Fi), BLUETOOTH™, ultra-wideband (UWB), etc.

The ever-increasing number of features and functionality introduced in wireless communication devices also creates a continuous need for improvement in both wireless communications and in wireless communication devices. In particular, it is important to ensure the accuracy of transmitted and received signals through user equipment (UE) devices, e.g., through wireless devices such as cellular phones, base stations and relay stations used in wireless cellular communications. In addition, increasing the functionality of a UE device can place a significant strain on the battery life of the UE device. Thus, it is very important to also reduce power requirements in UE device designs while allowing the UE device to maintain good transmit and receive abilities for improved communications. Accordingly, improvements in the field are desired.

### SUMMARY

Embodiments are presented herein of apparatuses, systems, and methods for providing multicast and broadcast services enhancements in a wireless communication system.

In some embodiments, a wireless device can perform a method including receiving, on a first component carrier (CC), a radio resource control (RRC) configuration message from a serving base station (BS), wherein the RRC configuration message can include at least one of multicast and broadcast services (MBS) scheduling information or configuration information. The method can further include receiving, on the first CC, a transmission from a MBS BS comprising additional MBS information. Furthermore, the method can include determining, based on the received at least one of MBS scheduling information or configuration information, a collision between a unicast transmission and a broadcast transmission. Additionally or alternatively, the wireless device can perform transmitting, to the MBS BS, an indication of interest related to MBS and receiving, on a second CC, a RRC reconfiguration message from the MBS BS. According to some embodiments, the RRC reconfiguration message can include at least one of adjusted scheduling information or configuration information corresponding to the unicast transmission. The method performed by the wireless device can further include receiving, from the MBS BS, the broadcast transmission. Additionally, the method performed by the wireless device can further include receiving, based at least in part on the at least one of adjusted scheduling information or configuration information, the unicast transmission from the serving BS, according to some embodiments.

According to some embodiments, the unicast transmission and broadcast transmission can be received at a same time. In some embodiments, the indication of interested can be reported via dedicated signaling and can include MBS interested information, user equipment (UE) assistance information, layer-3 (L3) signaling, layer-2 (L2) media access control-control element (MAC-CE) signaling, or layer-1 (L1) signaling. Additionally or alternatively, the indication of interest can include transmission duration information regarding at least one of the unicast transmission or broadcast transmission and further including information related to at least one of a preferred discontinuous reception (DRX) configuration, a periodicity, an offset, a duration, a switching time, or a switching gap.

In some embodiments, the indication of interest can include frequency information regarding at least one of the unicast transmission or broadcast transmission and further including information related to at least one of a frequency location, a bandwidth, or a subcarrier spacing. Additionally or alternatively, the indication of interest can include frequency information regarding at least one of the unicast transmission or broadcast transmission and information related to a preferred bandwidth part (BWP) corresponding to the first CC. According to some embodiments, the indication of interest can include frequency information regarding at least one of the unicast transmission or broadcast transmission and further includes information related to a preferred serving cell frequency corresponding to the second CC.

In some embodiments, the indication of interest can include frequency information regarding at least one of the unicast transmission or broadcast transmission and further include information related to a preferred bandwidth part (BWP) corresponding to the first CC. Additionally or alternatively, the indication of interest can include frequency information regarding at least one of the unicast transmission or broadcast transmission and further includes information related to a preferred exclusion of a frequency location corresponding to a range of physical resource blocks (PRBs) from a configured bandwidth (BW) of the first CC.

According to further embodiments, the indication of interest can include spatial information regarding at least one of the unicast transmission or broadcast transmission and further include information related to a preferred list of quasi-colocated (QCL) antenna ports of the first CC. Additionally or alternatively, the indication of interest can include information regarding the unicast transmission and further include information related to a preference to deactivate or deconfigure a secondary cell (SCell). In some embodiments, the indication of interest can include MBS information regarding at least one of the unicast transmission or broadcast transmission and further include information related to at least one of a MBS broadcast frequency or bandwidth.

In some embodiments, a base station (BS) can be configured to perform a method including transmitting, to a user equipment (UE), a capability request comprising multicast and broadcast services (MBS) specific information. The method can further include receiving, from the UE, a message comprising at least one of a capability report or MBS interested information. Additionally or alternatively, the method can include transmitting, to the UE, a radio resource control (RRC) reconfiguration message, wherein the RRC reconfiguration message includes at least one of adjusted scheduling information or configuration information corresponding to a unicast transmission. According to some embodiments, the method can further include transmitting, to the UE, a broadcast transmission using the at least one of adjusted scheduling information or configuration information.

In some embodiments, the capability report can include at least one of one or more band combination parameters or one or more feature set combination parameters. Additionally or alternatively, the MBS interested information can include at least one of one or more preferred band combinations or one or more preferred feature set combinations.

According to some embodiments, a user equipment (UE) can perform a method including

receiving, from a serving base station (BS), a radio resource control (RRC) configuration message including a request for the UE to report multicast and broadcast services (MBS) service information of one or more inter-public land mobility network (inter-PLMN) cells. The method can further include receiving, a transmission from a MBS BS comprising MBS configuration information corresponding to an inter-PLMN cell of the one or more inter-PLMN cells. Additionally or alternatively, the method can include reporting, in response receiving the request, MBS broadcast information to the serving BS corresponding to the inter-PLMN cell. In some embodiments, the method can include receiving, from the MBS BS, signaling on a multicast control channel (MCCH) including a change in a mapping between a temporary mobile group identity (TMGI) and a cell identifier (ID) of the inter-PLMN cell. Additionally or alternatively, the method can include transmitting, to the serving BS, the MBS broadcast information corresponding to the inter-PLMN cell including the change in the mapping between the TMGI and a cell ID of the inter-PLMN cell.

In some embodiments, the reporting of the MBS broadcast information can be performed according to a one-shot report mode corresponding to the UE reporting once. Additionally or alternatively, the reporting of the MBS broadcast information can be performed according to a periodical report mode corresponding to the UE reporting multiple times based on a configured periodicity or a MCCH modification period. According to some embodiments, the reporting of the MBS broadcast information can be performed according to a report on change mode corresponding to the UE reporting one or more times in response to one or more changes in the mapping between the TMGI and the cell ID of the inter-PLMN cell.

Note that the techniques described herein can be implemented in and/or used with a number of different types of devices, including but not limited to base stations, access points, cellular phones, portable media players, tablet computers, wearable devices, unmanned aerial vehicles, unmanned aerial controllers, automobiles and/or motorized vehicles, and various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the present subject matter can be obtained when the following detailed description of various embodiments is considered in conjunction with the following drawings, in which:

FIG. 1 illustrates an example (and simplified) wireless communication system, according to some embodiments;

FIG. 2 illustrates an example base station in communication with an example wireless user equipment (UE) device, according to some embodiments;

FIG. 3 illustrates an example block diagram of a UE, according to some embodiments;

FIG. 4 illustrates an example block diagram of a base station, according to some embodiments;

FIG. 5 illustrates an example block diagram of a cellular network element, according to some embodiments;

FIG. 6A is a block diagram illustrating aspects of decoupled processing for multicast and broadcast services in a wireless communication system, according to some embodiments;

FIG. 6B is a block diagram illustrating aspects of shared processing capabilities for multicast and broadcast services in a wireless communication system, according to some embodiments;

FIG. 7 is a communication flow diagram illustrating aspects of an example method for a base station (BS) coordinating multicast and broadcast services transmissions based on a specific UE capability, according to some embodiments;

FIG. 8 is a communication flow diagram illustrating aspects of an example method for a UE directed toward collision avoidance/mitigation related to multicast and broadcast services in a wireless communication system, according to some embodiments; and

FIGS. 9-17 illustrate additional example aspects and various possible approaches to collision avoidance/mitigation related to multicast and broadcast services in a wireless communication system, according to some embodiments.

While features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
UE: User Equipment
RF: Radio Frequency
BS: Base Station
GSM: Global System for Mobile Communication
UMTS: Universal Mobile Telecommunication System
LTE: Long Term Evolution
NR: New Radio
TX: Transmission/Transmit
RX: Reception/Receive
RAT: Radio Access Technology
TRP: Transmission-Reception-Point
gNB: Next Generation Node B
PRB: Physical Resource Block
DL: Downlink
NW: Network
RRC: Radio Resource Control
CC: Component Carrier
DC: Dual Connectivity
SCG: Secondary Cell Group
MBS: Multicast and Broadcast Services
SCell: Secondary Cell.
PCell: Primary Cell
SIB: System Information Block
MCCH: Multicast Control Channel
MTCH: Multicast Traffic Channel
MBMS: Multimedia Broadcast Multicast Services
TMGI: Temporary Mobile Group Identity
TDM: Time Domain Multiplexing.
FDM: Frequency Domain Multiplexing.
PLMN: Public Land Mobility Network
BW: Bandwidth
BWP: Bandwidth Part
SCS: Subcarrier Spacing
DRX: Discontinuous Reception
L1: Layer-1
L2: Layer-2
L3: Layer-3
MAC-CE: Media Access Control-Control Element
QCL: Quasi-Colocated
NID: Network Identifier
UAI: UE Assistance Information

### Terms

The following is a glossary of terms that can appear in the present disclosure:
Memory Medium—Any of various types of non-transitory memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer system for execution. The term “memory medium” can include two or more memory mediums which can reside in different locations, e.g., in different computer systems that are connected over a network. The memory medium can store program instructions (e.g., embodied as computer programs) that can be executed by one or more processors.
Carrier Medium—a memory medium as described above, as well as a physical transmission medium, such as a bus, network, and/or other physical transmission medium that conveys signals such as electrical, electromagnetic, or digital signals.
Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.
User Equipment (UE) (or “UE Device”)—any of various types of computer systems or devices that are mobile or portable and that perform wireless communications. Examples of UE devices include mobile telephones or smart phones (e.g., iPhone™, Android™-based phones), tablet computers (e.g., iPad™, Samsung Galaxy™), portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, other handheld devices, automobiles and/or motor vehicles, unmanned aerial vehicles (UAVs) (e.g., drones), UAV controllers (UACs), etc. In general, the term “UE” or “UE device” can be broadly defined to encompass any electronic, computing, and/or telecommunications device (or combination of devices) which is easily transported by a user and capable of wireless communication.
Wireless Device—any of various types of computer systems or devices that perform wireless communications. A wireless device can be portable (or mobile) or can be stationary or fixed at a certain location. A UE is an example of a wireless device.
Communication Device—any of various types of computer systems or devices that perform communications, where the communications can be wired or wireless. A communication device can be portable (or mobile) or can be stationary or fixed at a certain location. A wireless device is an example of a communication device. A UE is another example of a communication device.
Base Station (BS)—The term “Base Station” has the full breadth of its ordinary meaning, and at least includes a wireless communication station installed at a fixed location and used to communicate as part of a wireless telephone system or radio system.
Processing Element (or Processor)—refers to various elements or combinations of elements that are capable of performing a function in a device, e.g., in a user equipment device or in a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.
Wi-Fi—The term “Wi-Fi” has the full breadth of its ordinary meaning, and at least includes a wireless communication network or RAT that is serviced by wireless LAN (WLAN) access points and which provides connectivity through these access points to the Internet. Most modern Wi-Fi networks (or WLAN networks) are based on IEEE 802.11 standards and are marketed under the name “Wi-Fi”. A Wi-Fi (WLAN) network is different from a cellular network.
Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.
Configured to—Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112, paragraph six, interpretation for that component.

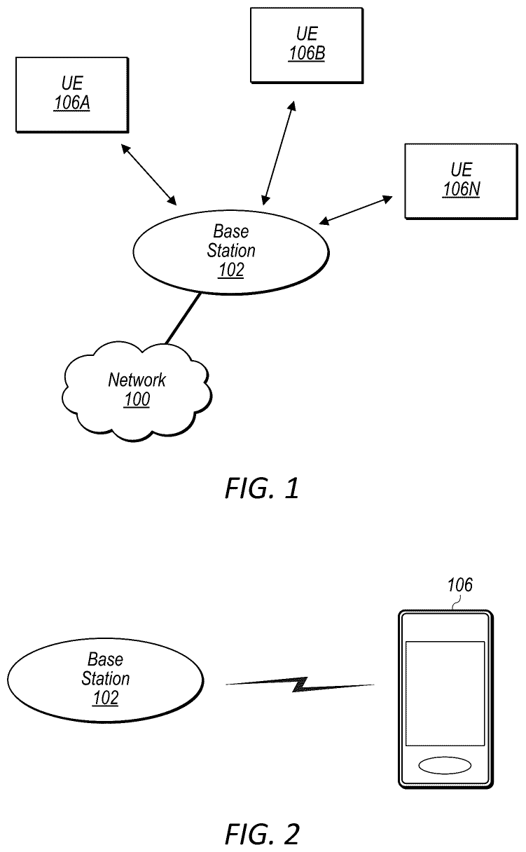

### FIGS. 1 and 2—Example Communication System

FIG. 1 illustrates an example (and simplified) wireless communication system in which aspects of this disclosure can be implemented, according to some embodiments. It is noted that the system of FIG. 1 is merely one example of a possible system, and embodiments can be implemented in any of various systems, as desired.

As shown, the example wireless communication system includes a base station 102 which communicates over a transmission medium with one or more (e.g., an arbitrary number of) user devices 106A, 106B, etc. through 106N. Each of the user devices can be referred to herein as a “user equipment” (UE) or UE device. Thus, the user devices 106 are referred to as UEs or UE devices.

The base station 102 can be a base transceiver station (BTS) or cell site, and can include hardware and/or software that enables wireless communication with the UEs 106A through 106N. If the base station 102 is implemented in the context of LTE, it can alternately be referred to as an ‘eNodeB’ or ‘eNB’. If the base station 102 is implemented in the context of 5G NR, it can alternately be referred to as a ‘gNodeB’ or ‘gNB’. The base station 102 can also be equipped to communicate with a network 100 (e.g., a core network of a cellular service provider, a telecommunication network such as a public switched telephone network (PSTN), and/or the Internet, among various possibilities). Thus, the base station 102 can facilitate communication among the user devices and/or between the user devices and the network 100. The communication area (or coverage area) of the base station can be referred to as a “cell.” As also used herein, from the perspective of UEs, a base station can sometimes be considered as representing the network insofar as uplink and downlink communications of the UE are concerned. Thus, a UE communicating with one or more base stations in the network can also be interpreted as the UE communicating with the network.

The base station 102 and the user devices can be configured to communicate over the transmission medium using any of various radio access technologies (RATs), also referred to as wireless communication technologies, or telecommunication standards, such as LTE, LTE-Advanced (LTE-A), LAA/LTE-U, 5G NR, Wi-Fi, UWB, etc.

Base station 102 and other similar base stations operating according to the same or a different cellular communication standard can thus be provided as one or more networks of cells, which can provide continuous or nearly continuous overlapping service to UE 106 and similar devices over a geographic area via one or more cellular communication standards.

Note that a UE 106 can be capable of communicating using multiple wireless communication standards. For example, a UE 106 might be configured to communicate using either or both of a 3GPP cellular communication standard or a 3GPP2 cellular communication standard. In some embodiments, the UE 106 can be configured to perform techniques for receiving multicast and broadcast services in a wireless communication system with radio access network sharing, such as according to the various methods described herein. The UE 106 might also or alternatively be configured to communicate using WLAN, BLUETOOTH™, one or more global navigational satellite systems (GNSS, e.g., GPS or GLONASS), one and/or more mobile television broadcasting standards (e.g., ATSC-M/H), etc. Other combinations of wireless communication standards (including more than two wireless communication standards) are also possible.

FIG. 2 illustrates an example user equipment 106 (e.g., one of the devices 106A through 106N) in communication with the base station 102, according to some embodiments. The UE 106 can be a device with wireless network connectivity such as a mobile phone, a hand-held device, a wearable device, a computer or a tablet, an unmanned aerial vehicle (UAV), an unmanned aerial controller (UAC), an automobile, or virtually any type of wireless device. The UE 106 can include a processor (processing element) that is configured to execute program instructions stored in memory. The UE 106 can perform any of the method embodiments described herein by executing such stored instructions. Alternatively, or in addition, the UE 106 can include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein. The UE 106 can be configured to communicate using any of multiple wireless communication protocols. For example, the UE 106 can be configured to communicate using two or more of LTE, LTE-A, 5G NR, WLAN, UWB, or GNSS. Other combinations of wireless communication standards are also possible.

The UE 106 can include one or more antennas for communicating using one or more wireless communication protocols according to one or more RAT standards. In some embodiments, the UE 106 can share one or more parts of a receive chain and/or transmit chain between multiple wireless communication standards. The shared radio can include a single antenna, or can include multiple antennas (e.g., for multiple-input, multiple-output or “MIMO”) for performing wireless communications. In general, a radio can include any combination of a baseband processor, analog RF signal processing circuitry (e.g., including filters, mixers, oscillators, amplifiers, etc.), or digital processing circuitry (e.g., for digital modulation as well as other digital processing). Similarly, the radio can implement one or more receive and transmit chains using the aforementioned hardware. For example, the UE 106 can share one or more parts of a receive and/or transmit chain between multiple wireless communication technologies, such as those discussed above.

In some embodiments, the UE 106 can include any number of antennas and can be configured to use the antennas to transmit and/or receive directional wireless signals (e.g., beams). Similarly, the BS 102 can also include any number of antennas and can be configured to use the antennas to transmit and/or receive directional wireless signals (e.g., beams). To receive and/or transmit such directional signals, the antennas of the UE 106 and/or BS 102 can be configured to apply different “weight” to different antennas. The process of applying these different weights can be referred to as “precoding”.

In some embodiments, the UE 106 can include separate transmit and/or receive chains (e.g., including separate antennas and other radio components) for each wireless communication protocol with which it is configured to communicate. As a further possibility, the UE 106 can include one or more radios that are shared between multiple wireless communication protocols, and one or more radios that are used exclusively by a single wireless communication protocol. For example, the UE 106 can include a shared radio for communicating using either of LTE or NR, and separate radios for communicating using each of Wi-Fi, UWB, and/or BLUETOOTH™. Other configurations are also possible.

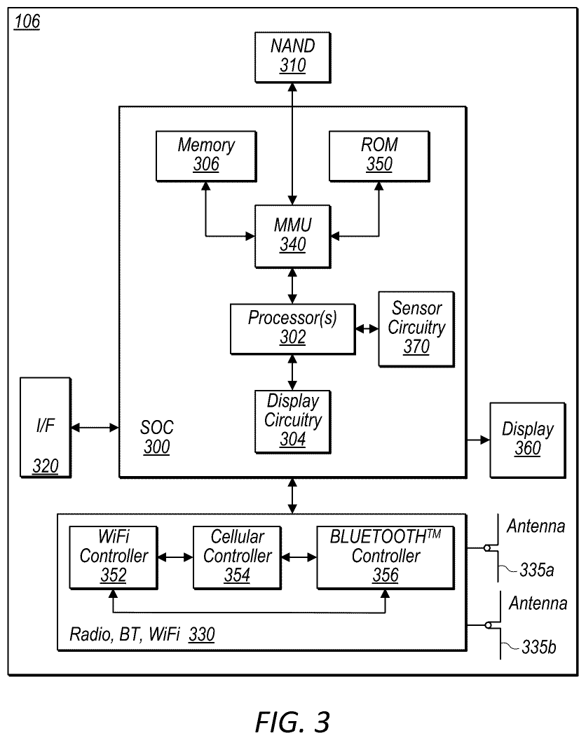

### FIG. 3—Block Diagram of an Example UE Device

FIG. 3 illustrates a block diagram of an example UE 106, according to some embodiments. As shown, the UE 106 can include a system on chip (SOC) 300, which can include portions for various purposes. For example, as shown, the SOC 300 can include processor(s) 302 which can execute program instructions for the UE 106 and display circuitry 304 which can perform graphics processing and provide display signals to the display 360. The SOC 300 can also include sensor circuitry 370, which can include components for sensing or measuring any of a variety of possible characteristics or parameters of the UE 106. For example, the sensor circuitry 370 can include motion sensing circuitry configured to detect motion of the UE 106, for example using a gyroscope, accelerometer, and/or any of various other motion sensing components. As another possibility, the sensor circuitry 370 can include one or more temperature sensing components, for example for measuring the temperature of each of one or more antenna panels and/or other components of the UE 106. Any of various other possible types of sensor circuitry can also or alternatively be included in UE 106, as desired. The processor(s) 302 can also be coupled to memory management unit (MMU) 340, which can be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 360. The MMU 340 can be configured to perform memory protection and page table translation or set up. In some embodiments, the MMU 340 can be included as a portion of the processor(s) 302.

As shown, the SOC 300 can be coupled to various other circuits of the UE 106. For example, the UE 106 can include various types of memory (e.g., including NAND flash memory 310), a connector interface 320 (e.g., for coupling to a computer system, dock, charging station, etc.), the display 360, and wireless communication circuitry 330 (e.g., for LTE, LTE-A, NR, BLUETOOTH™, Wi-Fi, UWB, GPS, etc.). The UE device 106 can include or couple to at least one antenna (e.g., 335a), and possibly multiple antennas (e.g., illustrated by antennas 335a and 335b), for performing wireless communication with base stations and/or other devices. Antennas 335a and 335b are shown by way of example, and UE device 106 can include fewer or more antennas. Overall, the one or more antennas are collectively referred to as antenna 335. For example, the UE device 106 can use antenna 335 to perform the wireless communication with the aid of radio circuitry 330. The communication circuitry can include multiple receive chains and/or multiple transmit chains for receiving and/or transmitting multiple spatial streams, such as in a multiple-input multiple output (MIMO) configuration. As noted above, the UE can be configured to communicate wirelessly using multiple wireless communication standards in some embodiments.

The UE 106 can include hardware and software components for implementing methods for the UE 106 to perform techniques for receiving multicast and broadcast services in a wireless communication system with radio access network sharing, such as described further subsequently herein. The processor(s) 302 of the UE device 106 can be configured to implement part or all of the methods described herein, e.g., by executing program instructions stored on a memory medium (e.g., a non-transitory computer-readable memory medium). In other embodiments, processor(s) 302 can be configured as a programmable hardware element, such as an FPGA (Field Programmable Gate Array), or as an ASIC (Application Specific Integrated Circuit). Furthermore, processor(s) 302 can be coupled to and/or can interoperate with other components as shown in FIG. 3, to perform techniques for receiving multicast and broadcast services in a wireless communication system with radio access network sharing according to various embodiments disclosed herein. Processor(s) 302 can also implement various other applications and/or end-user applications running on UE 106.

In some embodiments, radio 330 can include separate controllers dedicated to controlling communications for various respective RAT standards. For example, as shown in FIG. 3, radio 330 can include a Wi-Fi controller 352, a cellular controller (e.g., LTE and/or LTE-A controller) 354, and BLUETOOTH™ controller 356, and in at least some embodiments, one or more or all of these controllers can be implemented as respective integrated circuits (ICs or chips, for short) in communication with each other and with SOC 300 (and more specifically with processor(s) 302). For example, Wi-Fi controller 352 can communicate with cellular controller 354 over a cell-ISM link or WCI interface, and/or BLUETOOTH™ controller 356 can communicate with cellular controller 354 over a cell-ISM link, etc. While three separate controllers are illustrated within radio 330, other embodiments have fewer or more similar controllers for various different RATs that can be implemented in UE device 106.

Further, embodiments in which controllers can implement functionality associated with multiple radio access technologies are also envisioned. For example, according to some embodiments, the cellular controller 354 may, in addition to hardware and/or software components for performing cellular communication, include hardware and/or software components for performing one or more activities associated with Wi-Fi, such as Wi-Fi preamble detection, and/or generation and transmission of Wi-Fi physical layer preamble signals.

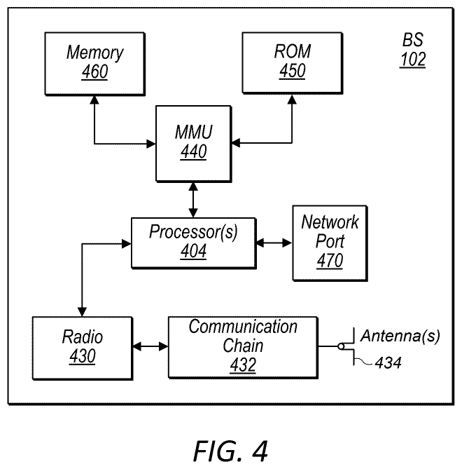

### FIG. 4—Block Diagram of an Example Base Station

FIG. 4 illustrates a block diagram of an example base station 102, according to some embodiments. It is noted that the base station of FIG. 4 is merely one example of a possible base station. As shown, the base station 102 can include processor(s) 404 which can execute program instructions for the base station 102. The processor(s) 404 can also be coupled to memory management unit (MMU) 440, which can be configured to receive addresses from the processor(s) 404 and translate those addresses to locations in memory (e.g., memory 460 and read only memory (ROM) 450) or to other circuits or devices.

The base station 102 can include at least one network port 470. The network port 470 can be configured to couple to a telephone network and provide a plurality of devices, such as UE devices 106, access to the telephone network as described above in FIGS. 1 and 2. The network port 470 (or an additional network port) can also or alternatively be configured to couple to a cellular network, e.g., a core network of a cellular service provider. The core network can provide mobility related services and/or other services to a plurality of devices, such as UE devices 106. In some cases, the network port 470 can couple to a telephone network via the core network, and/or the core network can provide a telephone network (e.g., among other UE devices serviced by the cellular service provider).

In some embodiments, base station 102 can be a next generation base station, e.g., a 5G New Radio (5G NR) base station, or “gNB”. In such embodiments, base station 102 can be connected to a legacy evolved packet core (EPC) network and/or to a NR core (NRC) network. In addition, base station 102 can be considered a 5G NR cell and can include one or more transmission and reception points (TRPs). In addition, a UE capable of operating according to 5G NR can be connected to one or more TRPs within one or more gNBs.

The base station 102 can include at least one antenna 434, and possibly multiple antennas. The antenna(s) 434 can be configured to operate as a wireless transceiver and can be further configured to communicate with UE devices 106 via radio 430. The antenna(s) 434 communicates with the radio 430 via communication chain 432. Communication chain 432 can be a receive chain, a transmit chain or both. The radio 430 can be designed to communicate via various wireless telecommunication standards, including, but not limited to, 5G NR, 5G NR SAT, LTE, LTE-A, UWB, Wi-Fi, etc.

The base station 102 can be configured to communicate wirelessly using multiple wireless communication standards. In some instances, the base station 102 can include multiple radios, which can enable the base station 102 to communicate according to multiple wireless communication technologies. For example, as one possibility, the base station 102 can include an LTE radio for performing communication according to LTE as well as a 5G NR radio for performing communication according to 5G NR. In such a case, the base station 102 can be capable of operating as both an LTE base station and a 5G NR base station. As another possibility, the base station 102 can include a multi-mode radio which is capable of performing communications according to any of multiple wireless communication technologies (e.g., 5G NR and Wi-Fi, 5G NR SAT and Wi-Fi, LTE and Wi-Fi, LTE and UWB, etc.).

As described further subsequently herein, the BS 102 can include hardware and software components for implementing or supporting implementation of features described herein. The processor 404 of the base station 102 can be configured to implement and/or support implementation of part or all of the methods described herein, e.g., by executing program instructions stored on a memory medium (e.g., a non-transitory computer-readable memory medium). Alternatively, the processor 404 can be configured as a programmable hardware element, such as an FPGA (Field Programmable Gate Array), or as an ASIC (Application Specific Integrated Circuit), or a combination thereof. In the case of certain RATs, for example Wi-Fi, base station 102 can be designed as an access point (AP), in which case network port 470 can be implemented to provide access to a wide area network and/or local area network(s), e.g., it can include at least one Ethernet port, and radio 430 can be designed to communicate according to the Wi-Fi standard.

In addition, as described herein, processor(s) 404 can include one or more processing elements. Thus, processor(s) 404 can include one or more integrated circuits (ICs) that are configured to perform the functions of processor(s) 404. In addition, each integrated circuit can include circuitry (e.g., first circuitry, second circuitry, etc.) configured to perform the functions of processor(s) 404.

Further, as described herein, radio 430 can include one or more processing elements. Thus, radio 430 can include one or more integrated circuits (ICs) that are configured to perform the functions of radio 430. In addition, each integrated circuit can include circuitry (e.g., first circuitry, second circuitry, etc.) configured to perform the functions of radio 430.

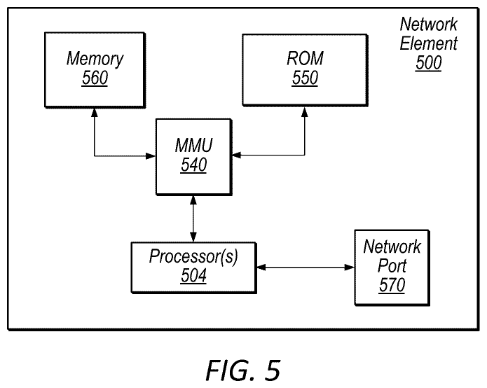

### FIG. 5—Example Block Diagram of a Network Element

FIG. 5 illustrates an example block diagram of a network element 500, according to some embodiments. According to some embodiments, the network element 500 can implement one or more logical functions/entities of a cellular core network, such as a mobility management entity (MME), serving gateway (S-GW), access and management function (AMF), session management function (SMF), etc. It is noted that the network element 500 of FIG. 5 is merely one example of a possible network element 500. As shown, the core network element 500 can include processor(s) 504 which can execute program instructions for the core network element 500. The processor(s) 504 can also be coupled to memory management unit (MMU) 540, which can be configured to receive addresses from the processor(s) 504 and translate those addresses to locations in memory (e.g., memory 560 and read only memory (ROM) 550) or to other circuits or devices.

The network element 500 can include at least one network port 570. The network port 570 can be configured to couple to one or more base stations and/or other cellular network entities and/or devices. The network element 500 can communicate with base stations (e.g., eNBs/gNBs) and/or other network entities/devices by means of any of various communication protocols and/or interfaces.

As described further subsequently herein, the network element 500 can include hardware and software components for implementing and/or supporting implementation of features described herein. The processor(s) 504 of the core network element 500 can be configured to implement or support implementation of part or all of the methods described herein, e.g., by executing program instructions stored on a memory medium (e.g., a non-transitory computer-readable memory medium). Alternatively, the processor 504 can be configured as a programmable hardware element, such as an FPGA (Field Programmable Gate Array), or as an ASIC (Application Specific Integrated Circuit), or a combination thereof.

### Simultaneous Reception of the Multicast and Broadcast Services (MBS) Broadcast and Unicast

In some scenarios, the Multicast and Broadcast Services (MBS) broadcast mechanism of a cellular network can provide the downlink (DL) only MBS delivery mode for all UEs in all radio resource control (RRC) states. Additionally or alternatively, a connected (e.g., in a CONNECTED state) UE can be configured to receive the unicast and MBS broadcast simultaneously in some scenarios. However, the network (NW) can possibly not be aware of all cases or scenarios and may need further information in order to provide the unicast and MBS broadcast simultaneously.

For example, the NW can become aware or determine that the UE is interested in receiving the simultaneous MBS broadcast service according to at least two methods. According to a first method, the connected UE can report a UE capability (e.g., a parameter such as broadcast-SCell-r17) to indicate whether the UE supports MBS broadcast reception on a secondary cell (SCell). Accordingly, if the UE interested MBS broadcast service is on the SCell on which the UE supports (broadcast-SCell-r17), the serving base station (e.g., gNB) can deliver a system information block of a certain format (e.g., SIBx) of that SCell to the UE. According to some embodiments, the SIBx can provide the multicast control channel (MCCH) configuration on the same cell. Furthermore, the UE can be able to receive the MBS broadcast service on a primary cell (PCell) and the SIBx can be acquired by the UE itself.

According to a second method, the connected UE can report or indicate that it is interested in receiving simultaneous MBS broadcast information to the NW (e.g., for service continuity purposes). Accordingly, the serving base station (e.g., gNB) can configure the UE (or provide configuration information) in such a way to allow the UE to receive the services the UE is interested in using the MBS broadcast. For example, the UE can transmit a MBS Interest Indication to the base station for broadcast session(s) consisting of various information. Additionally or alternatively, the information can include a MBS frequency list which can further be sorted in decreasing order of interest. In other words, the UE can be able to indicate preferred MBS frequencies to receive the MBS transmissions on. Additionally or alternatively, the information can include priority between the reception of all listed Multimedia Broadcast Multicast Services (MBMS) frequencies and the reception of any unicast bearer. Furthermore, the information can include a list of MBS services which the UE is receiving or interested in receiving. Enhancements to the Uu signaling can be introduced to enable simultaneous unicast/MBS broadcast reception. For example, a MBS related UE capability enhancement or MBS broadcast related assistance information enhancement can be made to reflect the shared processing capability such that the UE can receive the unicast/MBS broadcast simultaneously.

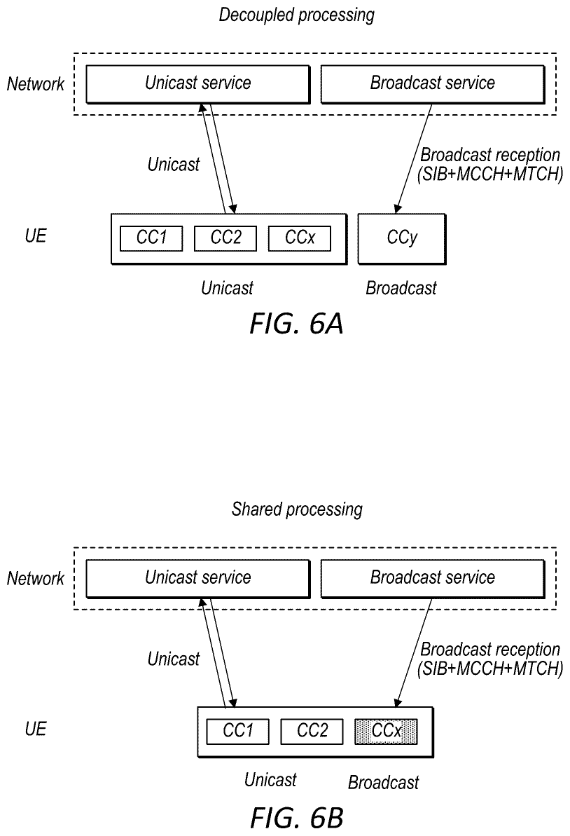

### FIGS. 6A-B—Decoupled and Shared Processing for Multicast and Broadcast Services

FIG. 6A is a block diagram illustrating aspects of decoupled processing for multicast and broadcast services in a wireless communication system, according to some embodiments. FIG. 6B is a block diagram illustrating aspects of shared processing for multicast and broadcast services in a wireless communication system, according to some embodiments.

According to some scenarios, the processing unit of broadcast and unicast can be decoupled. For example, as shown in FIG. 6A, the unicast service can be transmitting using component carriers 1, (CC1), CC2, and additional CCx while the MBS broadcast service can use CCy. Accordingly, the decoupled processing would be separate for the unicast (CC1, CC2, and CCx) and broadcast (CCy). Accordingly, the separated receptions of the MBS broadcast and unicast on their respective CCs can possibly not impact one another regarding processing capability.

Alternatively, for the shared processing design for MBS broadcast and unicast as shown in FIG. 6B, the MBS broadcast reception in one CC can impact the unicast processing capability in other CCs. For example, if a UE reports the UE capability to reflect the shared processing design, the network can be able to optimize the unicast scheduling and transmission performance if the broadcast is received at the same time.

In some scenarios, a broadcast service continuity mechanism can be applicable for the same operator deployment and the current serving base station (e.g., gNB) can be able to acquire the details of the MBS broadcast information from the MBS broadcast session context according to the reported MBS carrier or the temporary mobile group identifier (TMGI) information. Furthermore, if the UE interested MBS broadcast service is from another operator or third-party base station or gNB, the current serving base station (e.g., gNB) can possibly not be able to acquire the information from the stored context to select the appropriate serving cell/node which can provide the UE interested MBS service (for service continuity purposes). According to some scenarios, if a base station is aware or has determined the details of the UE interested MBS broadcast information from the UE side directly, the network can be able to provide or enact certain coordination actions between the unicast and MBS broadcast in order to avoid a collision case between the broadcast and unicast transmission and further avoid degradation regarding both transmission performances.

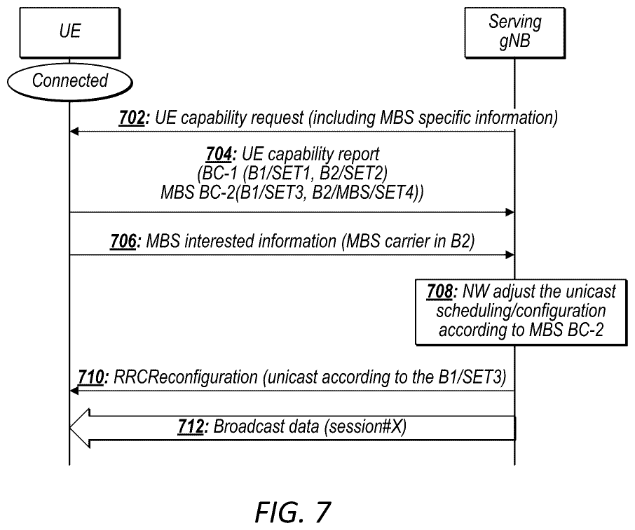

### FIG. 7—Communication Flow Diagram for Collision Avoidance/Mitigation for Multicast and Broadcast Services Using MBS Broadcast Specific UE Capability Design

In some embodiments, a MBS broadcast specific UE capability design can be envisioned for MBS broadcast transmission coordination by utilizing a specific MBS broadcast UE capability design. For example, within one band combination or feature set combination, at least one entry can be used to indicate for MBS broadcasting purposes. Accordingly, for the carrier or feature set entry with MBS broadcast indication, it can be used to indicate the UE capability of receiving the MBS broadcast there.

It can be beneficial to specify techniques for network and UE coordination as part of supporting multicast and broadcast services in a wireless communication system. To illustrate one such set of possible techniques, FIG. 7 is flow diagram illustrating aspects of an example method for a base station directed toward communication coordination using a MBS broadcast specific UE capability design and related to multicast and broadcast services in a wireless communication system, according to some embodiments.

Aspects of the method of FIG. 7 can be implemented by a cellular base station, e.g., in conjunction with one or more wireless devices, and/or other cellular network elements, such as a UE 106, a BS 102, and a cellular network element 500 illustrated in and described with respect to various of the Figures herein, or more generally in conjunction with any of the computer circuitry, systems, devices, elements, or components shown in the above Figures, among others, as desired. For example, a processor (and/or other hardware) of such a device can be configured to cause the device to perform any combination of the illustrated method elements and/or other method elements.

Note that while at least some elements of the method of FIG. 7 are described in a manner relating to the use of communication techniques and/or features associated with 3GPP and/or NR specification documents, such description is not intended to be limiting to the disclosure, and aspects of the method of FIG. 7 can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the method of FIG. 7 can operate as follows.

In 702, the BS can transmit a capability request to user equipment (UE). Additionally or alternatively, the UE capability request can include MBS specific information. For example, the BS can request specific information from the UE regarding its capability of receiving a MBS broadcast transmission using a specific band combination or feature set combination, according to some embodiments.

In 704, the BS can receive a capability report from the UE. Additionally or alternatively, the UE capability report can include indications of supported band combinations or feature set combinations for which the UE can utilize to receive the MBS broadcast transmission. Moreover, the UE can indicate a preferred band combination or feature set combination with which to use to receive the MBS broadcast transmission, according to some embodiments. For example, the capability report can include band combinations and/or feature set combinations such as BC-1 (B1/SET1, B2/SET2)) and/or MBS BC-2 (B1/SET3, B2/MBS/SET4) as shown in FIG. 7.

In 706, the UE can further transmit MBS interested information. Additionally or alternatively, the MBS interested information can include an indication that the UE is capable and/or prefers to receive the MBS broadcast using a carrier in B2, according to some embodiments. In other words, the UE can indicate to the network that it is capable of and would prefer to receive the MBS broadcast transmission using MBS BC-2.

In 708, the BS can adjust the unicast scheduling/configuration according to MBS BC-2. For example, having received the UE capability report and MBS interested information, the network (e.g., serving gNB) can adjust the unicast scheduling and/or configuration to incorporate the UE indicated capability and/or preferred band combination/feature set.

In 710, the BS can transmit a radio resource control (RRC) reconfiguration message to the UE. For example, having adjusted the unicast scheduling and/or configuration, the network could possibly need to send a reconfiguration control command to the UE in order for it to receive the broadcast. More specifically, the RRC command can indicate that the unicast should utilize a particular band combination and/or feature set combination such as B1/SET3 as previously indicated by the UE and corresponding to MBS BC-2, according to some embodiments.

In 712, the BS can transmit broadcast transmission to the UE. For example, the MBS broadcast transmission can contain data associated with a particular session (e.g., session #X), according to some embodiments.

In some embodiments, the method of FIG. 7 can involve a MBS specific band combination or the MBS specific feature set combination. More specifically, the band combination can include N bands for unicast and M bands for MBS broadcast. In some embodiments, the MBS band can be indicated by the MBS specific frequency in a NR band parameter. Additionally or alternatively, the feature set combination can include the N feature sets for unicast and M feature sets for MBS broadcast. In some embodiments, the MBS specific feature set can be indicated in the DL featureset level or the DL featureset per CC level. Accordingly, the MBS specific feature set (per CC) can be used for the UE receiving the MBS broadcast data.

In some embodiments, when the network (NW) is aware of the MBS reception on one carrier which belongs to one band combination/feature set combination, the NW can be able to use the feature set for the unicast in the same band combination/feature set combination. Additionally or alternatively, for the MBS specific band combination, the UE can be able to indicate the MBS band/CC information and therefore can possibly not need to provide the parameters in further detail.

According to some embodiments, a Dynamic UE capability report can be considered such that the dynamic report can be triggered by the NW or UE itself. Additionally or alternatively, the UE reports can be able to be based on the MBS broadcast carrier change, according to some embodiments.

Thus, at least according to some embodiments, the method of FIG. 7 can be used to provide a framework according to which a base station can be configured to perform coordination tasks for multicast and broadcast services in a wireless communication system, at least in some instances.

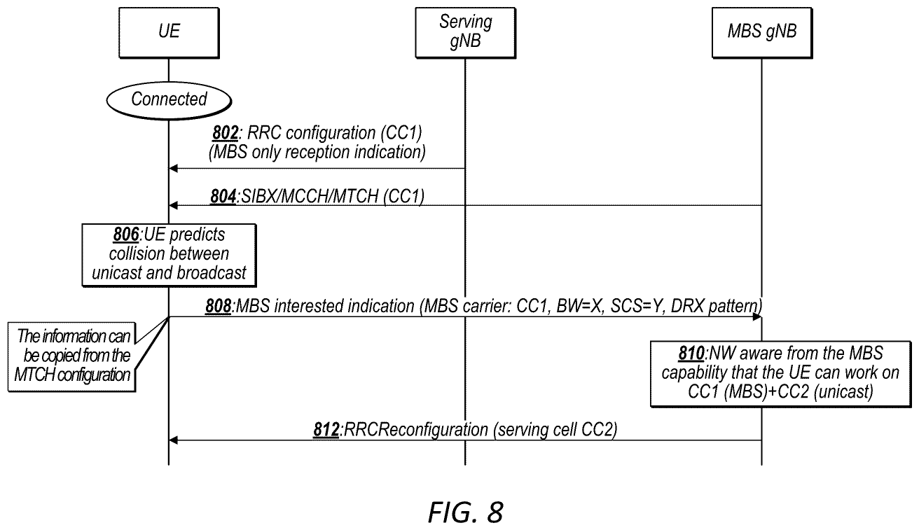

### FIG. 8—Communication Flow Diagram for Collision Avoidance/Mitigation for Multicast and Broadcast Services Using MBS Broadcast Associated UE Assistance Information Design

It can be further beneficial to specify techniques for collision avoidance/mitigation as part of supporting multicast and broadcast services in a wireless communication system. To illustrate one such set of possible techniques, FIG. 8 is flow diagram illustrating aspects of an example method for a user equipment directed toward collision avoidance/mitigation using a MBS broadcast associated UE assistance information design and related to multicast and broadcast services in a wireless communication system, according to some embodiments.

Aspects of the method of FIG. 8 can be implemented by a wireless device, e.g., in conjunction with one or more cellular base stations and/or other cellular network elements, such as a UE 106, a BS 102, and a cellular network element 500 illustrated in and described with respect to various of the Figures herein, or more generally in conjunction with any of the computer circuitry, systems, devices, elements, or components shown in the above Figures, among others, as desired. For example, a processor (and/or other hardware) of such a device can be configured to cause the device to perform any combination of the illustrated method elements and/or other method elements.

Note that while at least some elements of the method of FIG. 8 are described in a manner relating to the use of communication techniques and/or features associated with 3GPP and/or NR specification documents, such description is not intended to be limiting to the disclosure, and aspects of the method of FIG. 8 can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the method of FIG. 8 can operate as follows.

In 802, the UE can receive a radio resource control (RRC) configuration message from a serving base station on a first component carrier (CC1). Additionally or alternatively, the RRC configuration message can include an indication or information regarding the transmission or reception of a MBS transmission, according to some embodiments. In other words, the network can indicate to the UE that the configured CC1 for the UE is for MBS reception. Accordingly, the UE can follow the NW indication to perform MBS configuration acquisition and data reception there (e.g., using CC1).

In 804, the UE can receive a transmission from a multicast and broadcast services (MBS) BS. Furthermore, the transmission from the MBS BS can be on CC1 and further include information regarding MBS unicast and/or broadcast transmissions. For example, the transmission can include one or more system information blocks (SIBs) (e.g., SIBX), information corresponding to a multicast control channel (MCCH), and/or configuration information corresponding to a multicast traffic channel (MTCH), according to some embodiments.

In 806, the UE can determine a collision between unicast and broadcast transmissions. For example, the UE can utilize the information from the transmissions of 802 and 804 from the serving gNB and MBS gNB to determine that a collision of resources can occur between the unicast and broadcast transmissions, according to some embodiments. Furthermore, the collision(s) can result in degraded transmission performances corresponding to both the unicast and broadcast transmissions. Accordingly, the UE can seek to avoid said degradations, according to some embodiments.

In 808, the UE can transmit an indication of interest to the MBS BS. For example, the UE can transmit information including an indication of interest to the MBS BS and further include indications of preferences corresponding to preferred MBS carriers (e.g., CC1), preferred bandwidths (e.g., BW=X), preferred subcarrier spacing (e.g., SCS=Y), or preferred discontinuous reception (DRX) patterns, according to some embodiments. Additionally or alternatively, these indications of preferences can be copied from the MTCH configurations received by the UE in 804, according to some embodiments.

In 810, the network can become aware or determine that the UE is capable of working on CC1 for MBS and CC2 for unicast. For example, the MBS BS can utilize the provided information of 808 in order to configure the unicast to utilize CC2 and/or the MBS broadcast to use CC1, according to some embodiments.

In 812, the UE can receive a RRC reconfiguration from the MBS BS corresponding to a serving cell on a second CC (e.g., CC2). Accordingly the UE can utilize the RRC reconfiguration command such that it can receive the unicast on CC2 and the MBS broadcast on CC1, according to some embodiments.

In some embodiments, the UE Assistance Information Enhancement (e.g., MBS broadcast associated UE assistance information design) can include the UE reporting the details of the interested MBS broadcast information to the network. For example, the UE can report this information via UE dedicated signaling. Furthermore, the information can include MBS interested information, UE assistance information, Layer-3 (L3) signaling, Layer-2 (L2) media access control-control element (MAC-CE) signaling, and/or layer-1 (L1) signaling.

According to some embodiments, details of the interested MBS broadcast information can include the MBS broadcast information such as the MBS carrier, the MBS broadcast information for a third-party broadcast reception, and/or the transmission resource (from the MTCH configuration in the MBS carrier/cell) such as frequency location, bandwidth (BW), subcarrier spacing (SCS), and/or discontinuous reception (DRX) or data traffic patterns.

Additionally or alternatively, the interested MBS broadcast information can include preferred unicast scheduling/transmission configuration (to avoid the collision with MBS broadcast). In some embodiments, the interested MBS broadcast information can include the UE preferred BWP, serving cell activation/deactivation, transmission pattern and/or a dual connectivity (DC) configuration.

Moreover, the UE can be able to report the information when it can predict the collision between unicast and broadcast based on the configuration. Additionally or alternatively, for the unicast part, the collision prediction can be based on the activated or configured bandwidth part (BWP), secondary cell (SCell), or secondary cell group (SCG). In some embodiments, the UE can also report the information without such a collision prediction. Additionally or alternatively, the procedure can be enabled by the network via explicit signaling (e.g., explicit signaling in SIB or dedicated RRC configuration). According to some embodiments, the reporting can be retriggered when the UE interested MBS broadcast service is changed. Additionally or alternatively, the prohibit timer can be configured to control the reporting frequency, according to some embodiments.

Thus, at least according to some embodiments, the method of FIG. 8 can be used to provide a framework according to which a user equipment can be configured to perform collision avoidance/mitigation related tasks for multicast and broadcast services in a wireless communication system, at least in some instances.

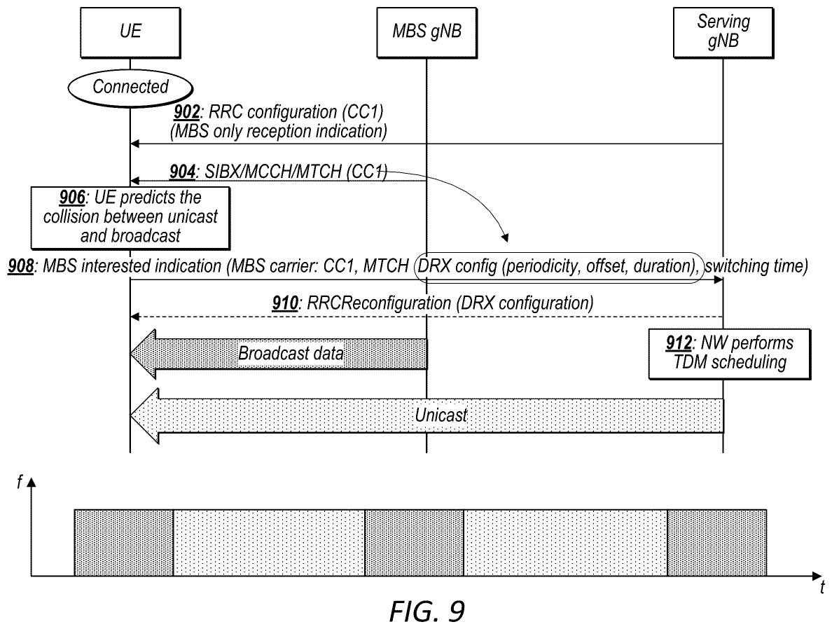

### FIGS. 9-17—Additional Information and Embodiments for Collision Avoidance/Mitigation for Multicast and Broadcast Services

FIGS. 9-17 illustrate example aspects of various possible approaches to collision avoidance/mitigation related to multicast and broadcast services in a wireless communication system, according to some embodiments.

Aspects of the methods of FIGS. 9-17 can be implemented by a wireless device, e.g., in conjunction with one or more cellular base stations and/or other cellular network elements, such as a UE 106, a BS 102, and a cellular network element 500 illustrated in and described with respect to various of the Figures herein, or more generally in conjunction with any of the computer circuitry, systems, devices, elements, or components shown in the above Figures, among others, as desired. For example, a processor (and/or other hardware) of such a device can be configured to cause the device to perform any combination of the illustrated method elements and/or other method elements.

Note that while at least some elements of the method of FIGS. 9-17 are described in a manner relating to the use of communication techniques and/or features associated with 3GPP and/or NR specification documents, such description is not intended to be limiting to the disclosure, and aspects of the method of FIGS. 9-17 can be used in any suitable wireless communication system, as desired. In various embodiments, some of the elements of the methods shown can be performed concurrently, in a different order than shown, can be substituted for by other method elements, or can be omitted. Additional method elements can also be performed as desired. As shown, the methods of FIG. 9-17 can operate as follows.

FIG. 9 is a communication flow diagram illustrating aspects of multicast and broadcast services broadcasts based on a MBS broadcast associated UE assistance information design. More specifically, FIG. 9 illustrates how time domain multiplexing (TDM) scheduling based on preferred DRX configurations can be utilized to perform said collision avoidance/mitigation of the unicast and broadcast transmissions.

For example, in 902, a UE in a connected state can receive a radio resource control (RRC) configuration message from a serving base station (gNB) on a first component carrier (CC1). Additionally or alternatively, the RRC configuration message can include an indication or information regarding the transmission or reception of a MBS transmission, according to some embodiments. In other words, the network can indicate to the UE that the configured CC1 for the UE is for MBS reception. Accordingly, the UE can follow the NW indication to perform MBS configuration acquisition and data reception there (e.g., using CC1).

In 904, the UE can receive a transmission from a multicast and broadcast services (MBS) BS. Furthermore, the transmission from the MBS BS can be on CC1 and further include information regarding MBS unicast and/or broadcast transmissions. For example, the transmission can include one or more system information blocks (SIBs) (e.g., SIBX), information corresponding to a multicast control channel (MCCH), and/or configuration information corresponding to a multicast traffic channel (MTCH), according to some embodiments.

In 906, the UE can determine a collision between unicast and broadcast transmissions. For example, the UE can utilize the information from the transmissions of 902 and 904 from the serving gNB and MBS gNB to determine that a collision of resources can occur between the unicast and broadcast transmissions, according to some embodiments. Furthermore, the collision(s) can result in degraded transmission performances corresponding to both the unicast and broadcast transmissions. Accordingly, the UE can seek to avoid said degradations, according to some embodiments.

In 908, the UE can transmit an indication of interest to the MBS BS. For example, the UE can transmit information including an indication of interest to the MBS BS and further include indications of preferences corresponding to preferred MBS carriers (e.g., CC1), MTCH DRX configurations (including periodicities, offsets, and durations), as well as switching times/gaps corresponding to the unicast and broadcast transmission, according to some embodiments. Additionally or alternatively, these indications of preferences and/or information can be copied from the MTCH configurations received by the UE in 904, according to some embodiments.

In 910, the UE can receive a RRC reconfiguration message from the serving gNB including information corresponding to a DRX configuration. Accordingly the UE can utilize the RRC reconfiguration and DRX configuration information such that it can expect to receive the unicast from the serving gNB and the MBS broadcast from the MBS gNB according to certain scheduling, according to some embodiments.

In 912, the network can perform time domain multiplexing (TDM) scheduling according to the DRX configurations provided in 910 such that the collision is avoided and the UE receives the unicast from the serving gNB and the MBS broadcast from the MBS gNB corresponding to the appropriate scheduling, according to some embodiments.

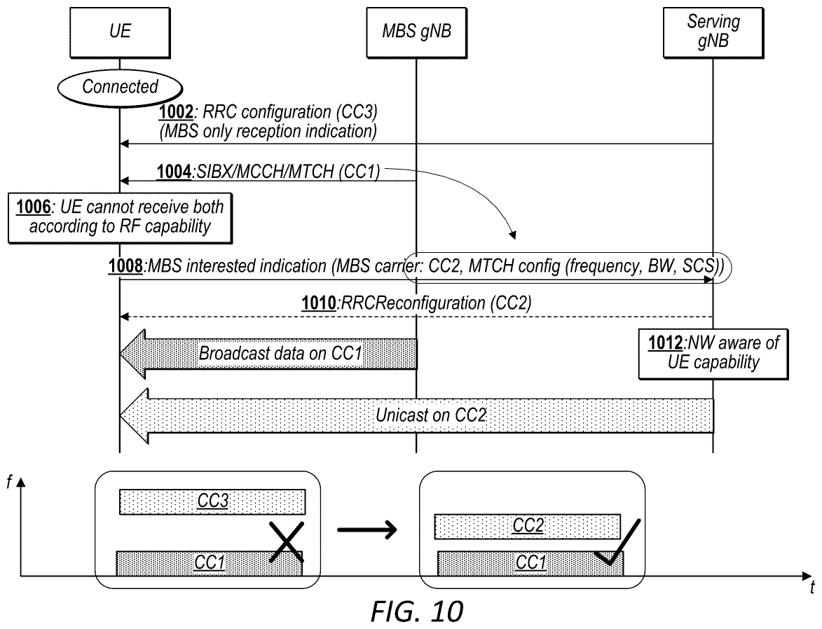

FIG. 10 illustrates an example scenario in which the UE can enable collision avoidance/mitigation for MBS using MBS broadcast associated UE assistance information design. More specifically, FIG. 10 illustrates how frequency domain multiplexing (FDM) scheduling based on preferred MTCH configurations can be utilized to perform said collision avoidance/mitigation of the unicast and broadcast transmissions.

For example, in 1002, a UE in a connected state can receive a radio resource control (RRC) configuration message from a serving base station (gNB) on a component carrier (CC3). Additionally or alternatively, the RRC configuration message can include an indication or information regarding the transmission or reception of a MBS transmission, according to some embodiments. In other words, the network can indicate to the UE that the configured CC3 for the UE is for MBS reception. Accordingly, the UE can follow the NW indication to perform MBS configuration acquisition and data reception there (e.g., using CC3).

In 1004, the UE can receive a transmission from a multicast and broadcast services (MBS) BS. Furthermore, the transmission from the MBS BS can be on a different component carrier (e.g., CC1) from the transmission of 1002 (e.g., CC3) and further include information regarding MBS unicast and/or broadcast transmissions. For example, the transmission can include one or more system information blocks (SIBs) (e.g., SIBX), information corresponding to a multicast control channel (MCCH), and/or configuration information corresponding to a multicast traffic channel (MTCH), according to some embodiments.

In 1006, the UE can determine or be aware that it cannot receive the unicast on CC3 and broadcast data on CC1. For example, the information provided in 1002 and 1004 can indicate that the unicast is to be received on CC3 and the broadcast data is to be received on CC1 but the UE can lack the radio-frequency (RF) capability to receive the unicast and broadcast using these indicated CCs. However, according to some embodiments, the UE can support a different configuration of CCs to receive the unicast and broadcast transmissions. For example, the UE can support receiving the broadcast on CC1 and the unicast on CC2, according to some embodiments.

Accordingly, in 1008, the UE can transmit interested indication to the serving BS (e.g., gNB). For example, the UE can transmit information including an indication of interest to the serving gNB and further include indications of preferences corresponding to preferred MBS carriers (e.g., CC1) and MTCH configurations (including frequencies, bandwidths, and subcarrier spacings) corresponding to the unicast and broadcast transmission, according to some embodiments. Additionally or alternatively, these indications of preferences and/or information can be copied from the MTCH configurations received by the UE in 1004, according to some embodiments.

In 1010, the UE can receive a RRC reconfiguration message from the serving gNB on a second CC (e.g., CC2). This RRC reconfiguration message can include information corresponding to a configuration based on the indication provided to the serving gNB from the UE in 1008 and corresponding to receiving the broadcast transmission on CC1 and the unicast transmission on CC2.

In 1012, the network can determine or be aware of the UE's capability based on the received indication provided by the UE in 1008. Accordingly the UE can further receive the unicast from the serving gNB on CC2 and the MBS broadcast from the MBS gNB on CC1, according to some embodiments. In other words, when the NW receives the indicated information as detailed in 1008, the NW can be able to reconfigure the serving cell from CC3 to CC2 such the transmissions of the unicast and broadcast are able to be properly received by the UE due to its support of CC1 and CC2 rather than CC1 and CC3.

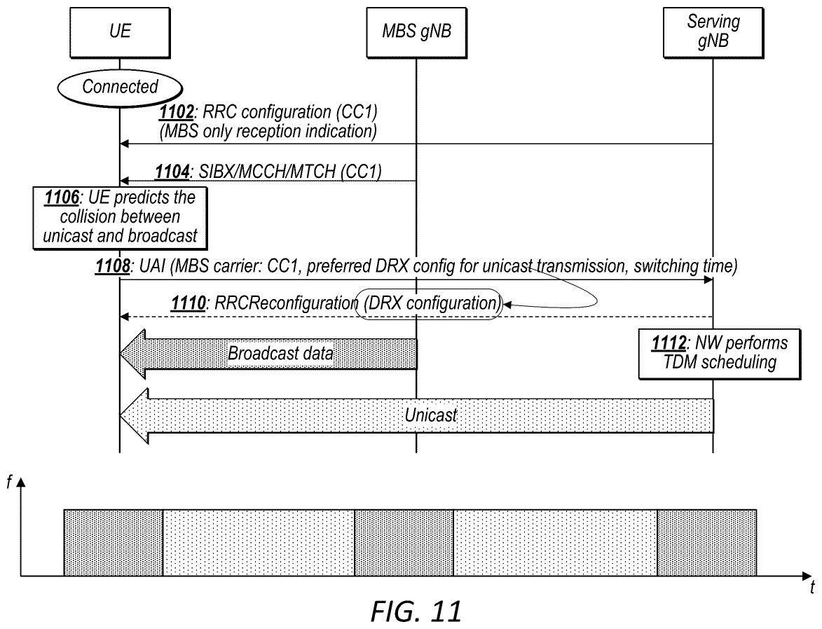

FIG. 11 illustrates another example scenario in which the UE can enable collision avoidance/mitigation for MBS using MBS broadcast associated UE assistance information design. More specifically, FIG. 11 illustrates how time domain multiplexing (TDM) scheduling based on preferred DRX configurations can be utilized to perform said collision avoidance/mitigation regarding the unicast and broadcast transmissions.

For example, in 1102, a UE in a connected state can receive a radio resource control (RRC) configuration message from a serving base station (gNB) on a first component carrier (CC1). Additionally or alternatively, the RRC configuration message can include an indication or information regarding the transmission or reception of a MBS transmission, according to some embodiments. In other words, the network can indicate to the UE that the configured CC1 for the UE is for MBS reception. Accordingly, the UE can follow the NW indication to perform MBS configuration acquisition and data reception there (e.g., using CC1).

In 1104, the UE can receive a transmission from a multicast and broadcast services (MBS) BS. Furthermore, the transmission from the MBS BS can be on CC1 and further include information regarding MBS unicast and/or broadcast transmissions. For example, the transmission can include one or more system information blocks (SIBs) (e.g., SIBX), information corresponding to a multicast control channel (MCCH), and/or configuration information corresponding to a multicast traffic channel (MTCH), according to some embodiments.

In 1106, the UE can determine a collision between unicast and broadcast transmissions. For example, the UE can utilize the information from the transmissions of 1102 and 1104 from the serving gNB and MBS gNB to determine that a collision of resources can occur between the unicast and broadcast transmissions, according to some embodiments. Furthermore, the collision(s) can result in degraded transmission performances corresponding to both the unicast and broadcast transmissions. Accordingly, the UE can seek to avoid said degradations, according to some embodiments.

In 1108, the UE can transmit UE assistance information (UAI) to the MBS BS. For example, the UE can transmit information including preferences corresponding to preferred MBS carriers (e.g., CC1), preferred DRX configurations (for unicast transmission), as well as switching times/gaps corresponding to the unicast and broadcast transmission, according to some embodiments. Additionally or alternatively, these indications of preferences and/or information can be copied from the MTCH configurations received by the UE in 1104, according to some embodiments.

In 1110, the UE can receive a RRC reconfiguration message from the serving gNB including information corresponding to specific DRX configuration. Accordingly, the UE can utilize the RRC reconfiguration and DRX configuration information such that it can expect to receive the unicast from the serving gNB and the MBS broadcast from the MBS gNB according to certain scheduling, according to some embodiments.

In 1112, the network can perform time domain multiplexing (TDM) scheduling according to the DRX configurations provided in 1110 such that the collision is avoided and the UE receives the unicast from the serving gNB and the MBS broadcast from the MBS gNB corresponding to the appropriate scheduling, according to some embodiments. In other words, when the network (NW) receives the appropriate UAI information from the UE, the NW can be able to perform the unicast scheduling in a TDM way such that a collision of resources corresponding to the MBS broadcast and unicast transmissions is avoided.

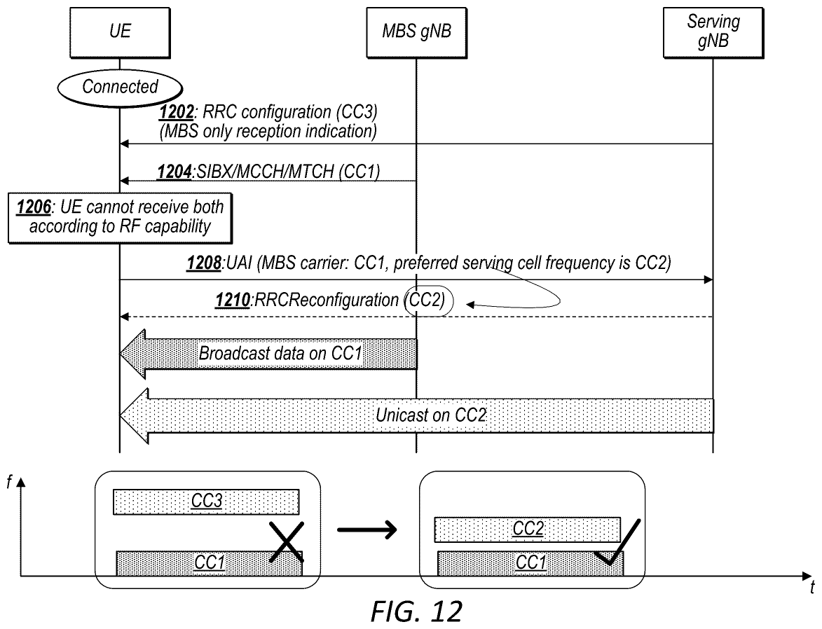

FIG. 12 illustrates yet another example scenario in which the UE can enable collision avoidance/mitigation for MBS using MBS broadcast associated UE assistance information design. More specifically, FIG. 12 illustrates how the network can perform frequency domain multiplexing (FDM) scheduling according to the specified and preferred serving cell frequency configurations so as to achieve collision avoidance/mitigation of unicast and broadcast transmissions.

For example, in 1202, a UE in a connected state can receive a radio resource control (RRC) configuration message from a serving base station (gNB) on a component carrier (CC3). Additionally or alternatively, the RRC configuration message can include an indication or information regarding the transmission or reception of a MBS transmission, according to some embodiments. In other words, the network can indicate to the UE that the configured CC3 for the UE is for MBS reception. Accordingly, the UE can follow the NW indication to perform MBS configuration acquisition and data reception there (e.g., using CC3).

In 1204, the UE can receive a transmission from a multicast and broadcast services (MBS) BS. Furthermore, the transmission from the MBS BS can be on a different component carrier (e.g., CC1) from the transmission of 1202 (e.g., CC3) and further include information regarding MBS unicast and/or broadcast transmissions. For example, the transmission can include one or more system information blocks (SIBs) (e.g., SIBX), information corresponding to a multicast control channel (MCCH), and/or configuration information corresponding to a multicast traffic channel (MTCH), according to some embodiments.

In 1206, the UE can determine or be aware that it cannot receive the unicast on CC3 and broadcast data on CC1. For example, the information provided in 1202 and 1204 can indicate that the unicast is to be received on CC3 and the broadcast data is to be received on CC1 but the UE can lack the radio-frequency (RF) capability to receive the unicast and broadcast using these indicated CCs. However, according to some embodiments, the UE can support a different configuration of CCs to receive the unicast and broadcast transmissions. For example, the UE can support receive the broadcast on CC1 and the unicast on CC2, according to some embodiments.

Accordingly, in 1208, the UE can transmit UE assistance information (UAI) to the serving BS (e.g., gNB). Furthermore, the UAI can include preferences corresponding to preferred MBS carriers (e.g., CC1) and preferred serving cell configurations or frequencies (e.g., CCs) corresponding to the unicast transmission, according to some embodiments. For example, the UAI can indicate that the preferred serving cell frequency is CC2.

In 1210, the UE can receive a RRC reconfiguration message from the serving gNB on a second CC (e.g., CC2). This RRC reconfiguration message can include information corresponding to a configuration based on the UAI provided to the serving gNB from the UE in 1208 and corresponding to receiving the broadcast transmission on CC1 and the unicast transmission on CC2 rather than on CC3. Accordingly, the UE can use the RRCReconfiguration information to appropriately receive the unicast from the serving gNB on CC2 and the MBS broadcast from the MBS gNB on CC1, according to some embodiments. In other words, when the NW receives the indicated information as detailed in 1208, the NW can be able to reconfigure the serving cell from CC3 to CC2 such the collision of unicast and broadcast transmissions is avoided.

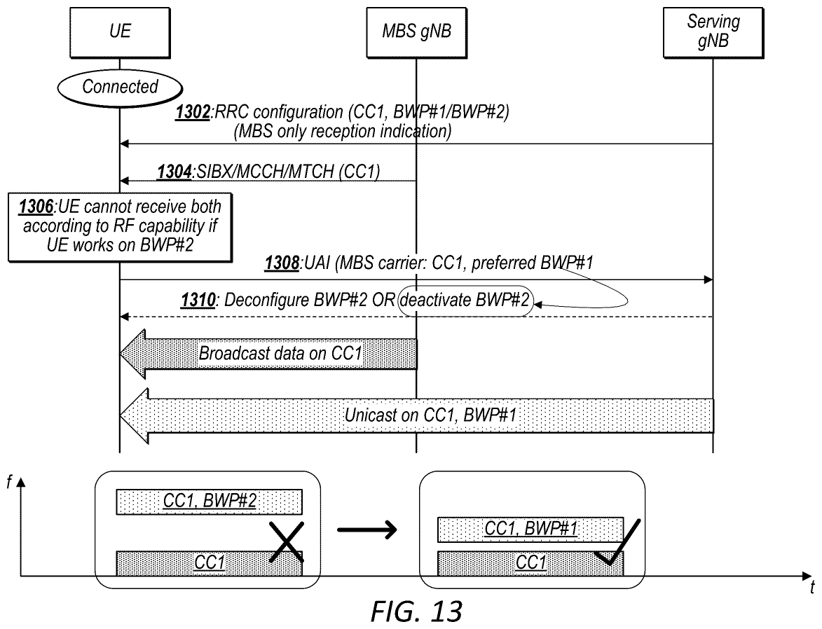

FIG. 13 illustrates an example scenario in which the UE can enable collision avoidance/mitigation for MBS using MBS broadcast associated UE assistance information design. More specifically, FIG. 13 illustrates how the network can perform frequency domain multiplexing (FDM) scheduling according to the specified and preferred BWP configurations so as to achieve collision avoidance/mitigation of unicast and broadcast transmissions.

For example, in 1302, a UE in a connected state can receive a radio resource control (RRC) configuration message from a serving base station (gNB) on a first component carrier (CC1). Furthermore, the RRC message can include information regarding receiving unicast and broadcast data using certain bandwidth parts (e.g., BWP#1, BWP#2). Additionally or alternatively, the RRC configuration message can include an indication or information regarding the transmission or reception of a MBS transmission, according to some embodiments. In other words, the network can indicate to the UE that the configured CC1 for the UE is for MBS reception. Accordingly, the UE can follow the NW indication to perform MBS configuration acquisition and data reception there (e.g., using CC1).

In 1304, the UE can receive a transmission from a multicast and broadcast services (MBS) BS. Furthermore, the transmission from the MBS BS can be on CC1 and further include information regarding MBS unicast and/or broadcast transmissions. For example, the transmission can include one or more system information blocks (SIBs) (e.g., SIBX), information corresponding to a multicast control channel (MCCH), and/or configuration information corresponding to a multicast traffic channel (MTCH), according to some embodiments.

In 1306, the UE can determine or be aware that it cannot receive the unicast on CC1 using BWP#2 and broadcast data on CC1. For example, the information provided in 1302 and 1304 can indicate that the unicast is to be received on CC1 using either BWP#1 or BWP#2 and the broadcast data is also to be received on CC1. Additionally, the UE can lack the radio-frequency (RF) capability to receive the unicast on CC1 using BWP#2, according to some embodiments. However, the UE can support a different configuration of CCs to receive the unicast and broadcast transmissions. For example, the UE can support receiving the broadcast on CC1 and the unicast on CC1 using BWP#1, according to some embodiments.

In 1308, the UE can transmit UE assistance information (UAI) to the MBS BS. For example, the UE can transmit information including preferences corresponding to preferred MBS carriers (e.g., CC1) and preferred BWP configurations (for unicast transmission), according to some embodiments. For example, the UAI can indicate that the UE prefers and/or supports BWP#1 for receiving the unicast on CC1, according to some embodiments.

In 1310, the UE can receive signaling from the serving gNB including information regarding the deconfiguration or deactivation of BWP#2. Accordingly, with BWP#2 deactivated or deconfigured, the UE can receive the unicast from the serving gNB on CC1 using the indicated and preferred BWP#1 (rather than the non-supported BWP#2) and the MBS broadcast from the MBS gNB on CC1, according to some embodiments. In other words, the network can perform frequency domain multiplexing (FDM) scheduling according to the specified and preferred BWP configurations (e.g., using BWP#1) provided in 1308 such that the collision is avoided and the UE receives the unicast from the serving gNB and the MBS broadcast from the MBS gNB corresponding to the appropriate scheduling, according to some embodiments. In other words, when the network (NW) receives the appropriate UAI information from the UE, the NW can be able to perform the unicast scheduling in a FDM way such that a collision of resources corresponding to the MBS broadcast and unicast transmissions is avoided.

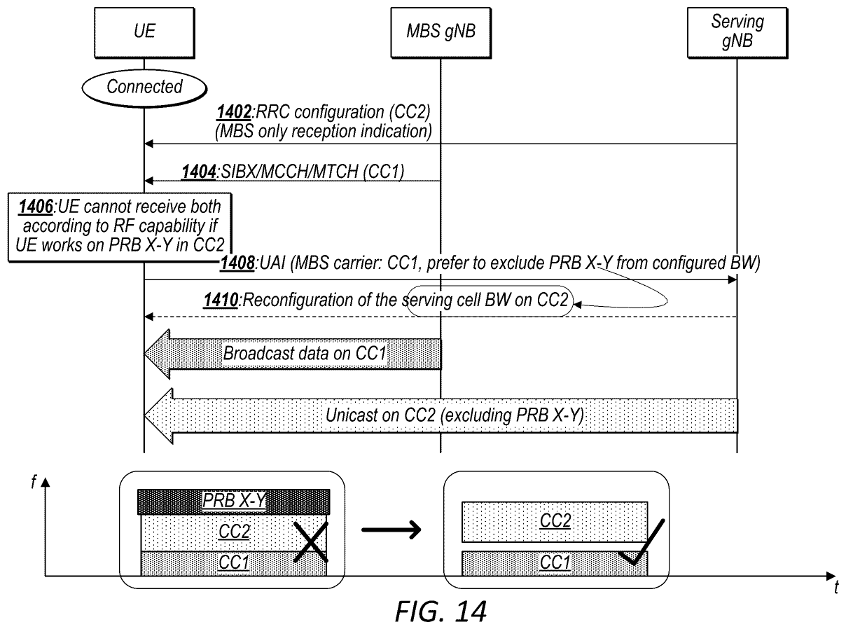

FIG. 14 illustrates an example scenario in which the UE can enable collision avoidance/mitigation for MBS using MBS broadcast associated UE assistance information design. More specifically, FIG. 14 illustrates how frequency domain multiplexing (FDM) the preferred unicast information of the MBS broadcast information can be utilized to perform said collision avoidance/mitigation.

For example, in 1402, a UE in a connected state can receive a radio resource control (RRC) configuration message from a serving base station (gNB) on a component carrier (CC2). Additionally or alternatively, the RRC configuration message can include an indication or information regarding the transmission or reception of a MBS transmission, according to some embodiments. In other words, the network can indicate to the UE that the configured CC2 for the UE is for MBS reception. Accordingly, the UE can follow the NW indication to perform MBS configuration acquisition and data reception there (e.g., using CC2).

In 1404, the UE can receive a transmission from a multicast and broadcast services (MBS) BS. Furthermore, the transmission from the MBS BS can be on a different component carrier (e.g., CC1) from the transmission of 1402 (e.g., CC2) and further include information regarding MBS unicast and/or broadcast transmissions. For example, the transmission can include one or more system information blocks (SIBs) (e.g., SIBX), information corresponding to a multicast control channel (MCCH), and/or configuration information corresponding to a multicast traffic channel (MTCH), according to some embodiments.

In 1406, the UE can determine or be aware that it is unable to receive the unicast on CC2 (under certain conditions) and broadcast data on CC1. For example, the information provided in 1402 and 1404 can indicate that the broadcast data is to be received on CC1 and the unicast is to be received on CC2 using certain physical resource blocks (PRBs). However, the UE can lack the radio-frequency (RF) capability to receive the unicast using a specific number or range (e.g., X-Y) of PRBs. Additionally, according to some embodiments, the UE can support a different configuration of CC2 to receive the unicast and broadcast transmissions through exclusion of the non-supported PRBs.

Accordingly, in 1408, the UE can transmit UE assistance information (UAI) to the serving BS (e.g., gNB). Furthermore, the UAI can include preferences corresponding to preferred MBS carriers (e.g., CC1) and a preference to exclude a number or range of PRBs (e.g., PRBs X-Y) from the configured bandwidth, according to some embodiments.

In 1410, the UE can receive a RRC reconfiguration message from the serving gNB on a second CC (e.g., CC2). This RRC reconfiguration message can include information corresponding to a reconfiguration of CC2 based on the UAI provided to the serving gNB from the UE in 1408 and corresponding to the exclusion of PRBs X-Y from CC2. Accordingly, the UE can use the RRCReconfiguration information to appropriately receive the unicast from the serving gNB on CC2 (without the use of PRBs X-Y) and the MBS broadcast from the MBS gNB on CC1, according to some embodiments. For example, when the NW receives the indicated information as detailed in 1408, the serving gNB can be able to reconfigure the serving cell CC2 to exclude the unsupported PRBs X-Y such that the unicast and broadcast transmissions can be successfully received.

In other words, the UE can possibly not be able to receive the MBS and unicast on CC1 if the unicast is scheduled/configured in the PRB range (x-y) of CC2. Furthermore, the UE can then provide the unpreferred PRBs for unicast information (or equivalent information regarding a. preferred PRB frequency location) to the network. Accordingly, when the network receives the information, the NW can be able to reconfigure the CC2 so as to exclude the frequency location of the PRB range (x-y) from the configured BW and therefore avoid the collision occurrence between the unicast and broadcast transmissions, according to some embodiments.

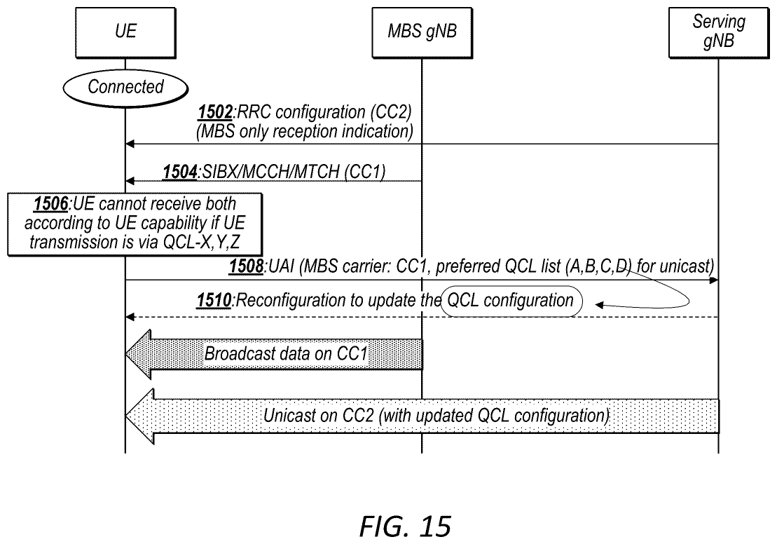

FIG. 15 illustrates yet another example scenario in which the UE can enable collision avoidance/mitigation for MBS using MBS broadcast associated UE assistance information design. More specifically, FIG. 15 illustrates how the spatial level preferred unicast information of the MBS broadcast information can be utilized to perform said collision avoidance/mitigation.

For example, in 1502, a UE in a connected state can receive a radio resource control (RRC) configuration message from a serving base station (gNB) on a component carrier (CC2). Additionally or alternatively, the RRC configuration message can include an indication or information regarding the transmission or reception of a MBS transmission, according to some embodiments. In other words, the network can indicate to the UE that the configured CC2 for the UE is for MBS reception. Accordingly, the UE can follow the NW indication to perform MBS configuration acquisition and data reception there (e.g., using CC2).

In 1504, the UE can receive a transmission from a multicast and broadcast services (MBS) BS. Furthermore, the transmission from the MBS BS can be on a different component carrier (e.g., CC1) from the transmission of 1502 (e.g., CC2) and further include information regarding MBS unicast and/or broadcast transmissions. For example, the transmission can include one or more system information blocks (SIBs) (e.g., SIBX), information corresponding to a multicast control channel (MCCH), and/or configuration information corresponding to a multicast traffic channel (MTCH), according to some embodiments.

In 1506, the UE can determine or be aware that it is unable to receive the unicast on CC2 (under certain conditions) and broadcast data on CC1. For example, the information provided in 1502 and 1504 can indicate that the broadcast data is to be received on CC1 and the unicast is to be received on CC2 using certain quasi-colocated (QCL) antenna ports. Additionally, the UE can lack capability to receive the unicast on CC2 on QCL antenna ports X, Y, and/or Z, according to some embodiments. In other words, the UE can possibly not be able to receive the MBS and unicast if the unicast is scheduled/configured with some special or particular QCL antenna ports (e.g., X,Y,Z). However, in some scenarios, the UE can support a different configuration of CC2 (e.g., using preferred QCL antenna ports such as A B, C, and/or D) to receive the unicast.

Accordingly, in 1508, the UE can transmit UE assistance information (UAI) to the serving BS (e.g., gNB). Furthermore, the UAI can include preferences corresponding to preferred MBS carriers (e.g., CC1) and a list of preferred QCL antenna ports for unicast, according to some embodiments.

In 1510, the serving gNB can transmit a reconfiguration message to the UE so as to update the QCL configuration for CC2. In other words, the network can be able to adjust the configured/activated QCL list for the unicast so as to avoid a collision between the unicast and broadcast transmissions, according to some embodiments.

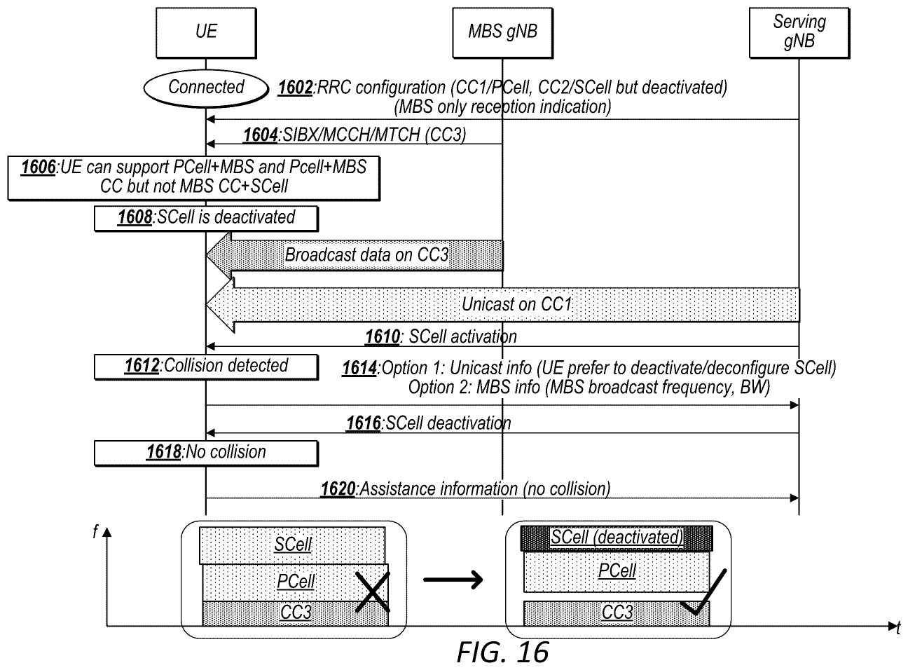

FIG. 16 illustrates an example scenario in which the UE can enable collision avoidance/mitigation for MBS using MBS broadcast associated UE assistance information design. More specifically, FIG. 16 illustrates how an assistance information trigger based on the activated serving cell set can be utilized to avoid a collision between the unicast and broadcast transmissions.

For example, in 1602, a UE in a connected state can receive a radio resource control (RRC) configuration message from a serving base station (gNB) regarding a primary cell (PCell) on CC1 and a deactivated secondary cell (SCell) on a component carrier (CC2). Additionally or alternatively, the RRC configuration message can include an indication or information regarding the transmission or reception of a MBS transmission, according to some embodiments. In other words, the network can indicate to the UE that the configured PCell associated with CC1 for the UE is for MBS reception. Accordingly, the UE can follow the NW indication to perform MBS configuration acquisition and data reception there (e.g., using the PCell associated with CC1).

In 1604, the UE can receive a transmission from a multicast and broadcast services (MBS) BS. Furthermore, the transmission from the MBS BS can be on a different component carrier (e.g., CC3) from the transmission of 1602 and further include information regarding MBS unicast and/or broadcast transmissions. For example, the transmission can include one or more system information blocks (SIBs) (e.g., SIBX), information corresponding to a multicast control channel (MCCH), and/or configuration information corresponding to a multicast traffic channel (MTCH), according to some embodiments.

In 1606, the UE can determine or be aware that it is able to support the reception of the broadcast data on CC3 and the unicast using a PCell. However, the UE can possibly not be able to receive the unicast on a SCell in addition to the PCell. In other words, the UE can be able to support receiving MBS on a PCell and CC but not on a CC and a SCell. Accordingly, in 1608, the UE can enact a deactivation of the SCell to as to receive the broadcast data on CC3 and the unicast on CC1 corresponding to the PCell.

In some embodiments, the serving gNB can further then activate the SCell in 1610. Accordingly, the UE can further detect a collision in 1612 and proceed to 1614 to provide certain information to the serving gNB in reponse to the collision detection. For example, as one option, the UE can provide unicast information to the serving gNB further including an indication that it prefers to deactivate or deconfigure the SCell. Additionally or alternatively, the UE can provide MBS information to the serving gNB such as MBS broadcast frequency and/or bandwidth, according to some embodiments.

Accordingly, in 1616, in the SCell can be deactivated once again to avoid (as in 1618) the uncast and broadcast collision. Furthermore, in 1620 the UE can then provide assistance information to the serving gNB and further indicate that a collision has not occurred.

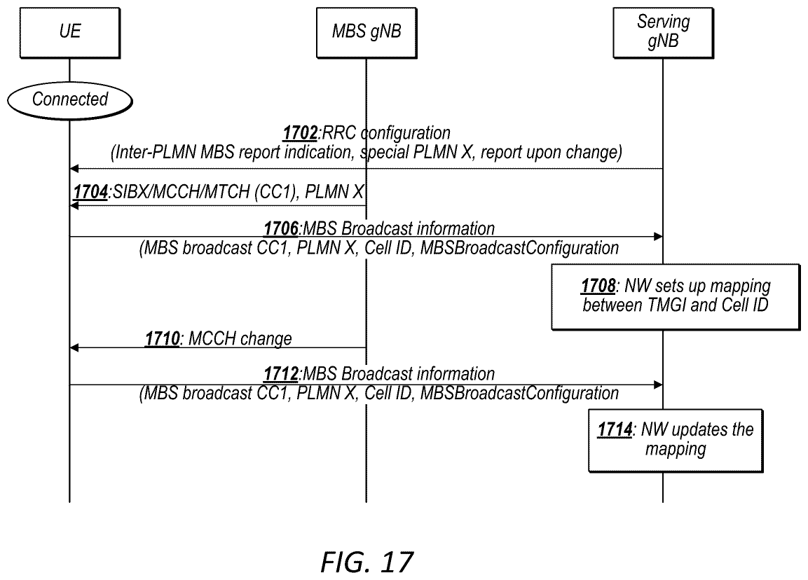

FIG. 17 illustrates an example scenario in which the UE can enable collision avoidance/mitigation for MBS using the UE's Inter-PLMN MBS broadcast services reporting. More specifically, FIG. 17 illustrates how a network can setup and update mappings between the TMGI and the Cell ID based on a requested report of MBS broadcast service information of the inter-PLMN cells from the UE.

For example, in 1702, the network (e.g., gNB) can request one or more UEs to report the MBS broadcast service information of the inter-PLMN cells. This request can be in the form of an RRC configuration transmission and include information regarding the request such as a specific or special PLMN X that can belong to a different PLMN or operator. Furthermore the RRC configuration message can include information regarding a reporting mode for the UE to implement. For example, in some embodiments, the network (NW) can trigger the report in various modes including one-shot report mode, periodical report mode, or report upon change mode, according to some embodiments. Additionally or alternatively, the network can request the report for some specific PLMNs and/or some specific NIDs. Furthermore, in 1704, the UE can receive another transmission on CC1 including one or more system information blocks (SIBs) (e.g., SIBX), information corresponding to a multicast control channel (MCCH), and/or configuration information corresponding to a multicast traffic channel (MTCH) and related information pertaining to PLMN X, according to some embodiments.

Accordingly, the UE may, upon receiving the request, perform additional operations. For example, when the connected UE receives or intends to receive the MBS broadcast service on a non-serving cell which belongs to a different PLMN/operator, the UE may, in 1706, report the SIBx and MBSBroadcastConfiguration (delivered via MCCH) to the current serving gNB via dedicated signaling, according to some embodiments. Additionally or alternatively, the MBS broadcast information can include a preferred CC of the MBS broadcast (e.g., CC1), information regarding PLMN X as well as a cell identifier (ID). Furthermore, if the UE is in one-shot report mode, the UE can be configured to report one time. Additionally or alternatively, if the UE is in periodical report mode, the UE can be configured to report the latest configuration as indicated or configured with a certain periodicity (or according to the MCCH modification period), according to some embodiments. In some embodiments, if the UE is in report upon change mode, the UE can report upon the MCCH change case.

In 1708, the network can set up a mapping between a temporary mobile group identifier (TMGI) and the cell ID based on the received information in 1706. In 1710, the MBS gNB can further indicate a change in the mapping regarding the Cell ID via a MCCH transmission. Accordingly, in 1712, the UE can transmit this updated information to the serving gNB so that it can update the mapping in 1714.

Accordingly, in some embodiments, a wireless device can perform a method including receiving, on a first component carrier (CC), a radio resource control (RRC) configuration message from a serving base station (BS), wherein the RRC configuration message can include at least one of multicast and broadcast services (MBS) scheduling information or configuration information. The method can further include receiving, on the first CC, a transmission from a MBS BS comprising additional MBS information. Furthermore, the method can include determining, based on the received at least one of MBS scheduling information or configuration information, a collision between a unicast transmission and a broadcast transmission. Additionally or alternatively, the wireless device can perform transmitting, to the MBS BS, an indication of interest related to MBS and receiving, on a second CC, a RRC reconfiguration message from the MBS BS. According to some embodiments, the RRC reconfiguration message can include at least one of adjusted scheduling information or configuration information corresponding to the unicast transmission. The method performed by the wireless device can further include receiving, from the MBS BS, the broadcast transmission. Additionally, the method performed by the wireless device can further include receiving, based at least in part on the at least one of adjusted scheduling information or configuration information, the unicast transmission from the serving BS, according to some embodiments.

According to some embodiments, the indication of interested can be reported via dedicated signaling and can include MBS interested information, user equipment (UE) assistance information, layer-3 (L3) signaling, layer-2 (L2) media access control-control element (MAC-CE) signaling, or layer-1 (L1) signaling. Additionally or alternatively, the indication of interest can include MBS transmission duration information regarding at least one of the unicast transmission or broadcast transmission and further including information related to at least one of a preferred discontinuous reception (DRX) configuration, a periodicity, an offset, a duration, a switching time, or a switching gap.

In some embodiments, the indication of interest can include frequency information regarding at least one of the unicast transmission or broadcast transmission and further including information related to at least one of a frequency location, a bandwidth, or a subcarrier spacing. Additionally or alternatively, the indication of interest can include frequency information regarding at least one of the unicast transmission or broadcast transmission and information related to a preferred bandwidth part (BWP) corresponding to the first CC. According to some embodiments, the indication of interest can include frequency information regarding at least one of the unicast transmission or broadcast transmission and further includes information related to a preferred serving cell frequency corresponding to the second CC.

In some embodiments, the indication of interest can include frequency information regarding at least one of the unicast transmission or broadcast transmission and further include information related to a preferred bandwidth part (BWP) corresponding to the first CC. Additionally or alternatively, the indication of interest can include frequency information regarding at least one of the unicast transmission or broadcast transmission and further includes information related to a preferred exclusion of a frequency location corresponding to a range of physical resource blocks (PRBs) from a configured bandwidth (BW) of the first CC.

According to further embodiments, the indication of interest can include spatial information regarding at least one of the unicast transmission or broadcast transmission and further include information related to a preferred list of quasi-colocated (QCL) antenna ports of the first CC. Additionally or alternatively, the indication of interest can include information regarding the unicast transmission and further include information related to a preference to deactivate or deconfigure a secondary cell (SCell). In some embodiments, the indication of interest can include MBS information regarding at least one of the unicast transmission or broadcast transmission and further include information related to at least one of a MBS broadcast frequency or bandwidth.

In some embodiments, a base station (BS) can be configured to perform a method including transmitting, to a user equipment (UE), a capability request comprising multicast and broadcast services (MBS) specific information. The method can further include receiving, from the UE, a message comprising at least one of a capability report or MBS interested information. Additionally or alternatively, the method can include transmitting, to the UE, a radio resource control (RRC) reconfiguration message, wherein the RRC reconfiguration message includes at least one of adjusted scheduling information or configuration information corresponding to a unicast transmission. According to some embodiments, the method can further include transmitting, to the UE, a broadcast transmission using the at least one of adjusted scheduling information or configuration information.

In some embodiments, the capability report can include at least one of one or more band combination parameters or one or more feature set combination parameters. Additionally or alternatively, the MBS interested information can include at least one of one or more preferred band combinations or one or more preferred feature set combinations.

According to some embodiments, a user equipment (UE) can perform a method including receiving, from a serving base station (BS), a radio resource control (RRC) configuration message including a request for the UE to report multicast and broadcast services (MBS) service information of one or more inter-public land mobility network (inter-PLMN) cells. The method can further include receiving, a transmission from a MBS BS comprising MBS configuration information corresponding to an inter-PLMN cell of the one or more inter-PLMN cells. Additionally or alternatively, the method can include reporting, in response receiving the request, MBS broadcast information to the serving BS corresponding to the inter-PLMN cell. In some embodiments, the method can include receiving, from the MBS BS, signaling on a multicast control channel (MCCH) including a change in a mapping between a temporary mobile group identity (TMGI) and a cell identifier (ID) of the inter-PLMN cell. Additionally or alternatively, the method can include transmitting, to the serving BS, the MBS broadcast information corresponding to the inter-PLMN cell including the change in the mapping between the TMGI and a cell ID of the inter-PLMN cell.

In some embodiments, the reporting of the MBS broadcast information can be performed according to a one-shot report mode corresponding to the UE reporting once. Additionally or alternatively, the reporting of the MBS broadcast information can be performed according to a periodical report mode corresponding to the UE reporting multiple times based on a configured periodicity or a MCCH modification period. According to some embodiments, the reporting of the MBS broadcast information can be performed according to a report on change mode corresponding to the UE reporting one or more times in response to one or more changes in the mapping between the TMGI and the cell ID of the inter-PLMN cell.

A further example embodiment can include a method, comprising: performing, by a wireless device, any or all parts of the preceding examples.

Another example embodiment can include a device, comprising: an antenna; a radio coupled to the antenna; and a processing element operably coupled to the radio, wherein the device is configured to implement any or all parts of the preceding examples.

A further example set of embodiments can include a non-transitory computer accessible memory medium comprising program instructions which, when executed at a device, cause the device to implement any or all parts of any of the preceding examples.

A still further example set of embodiments can include a computer program comprising instructions for performing any or all parts of any of the preceding examples.

Yet another example set of embodiments can include an apparatus comprising means for performing any or all of the elements of any of the preceding examples.

Still another example set of embodiments can include an apparatus comprising a processing element configured to cause a wireless device to perform any or all of the elements of any of the preceding examples.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Any of the methods described herein for operating a user equipment (UE) can be the basis of a corresponding method for operating a base station, by interpreting each message/signal X received by the UE in the downlink as message/signal X transmitted by the base station, and each message/signal Y transmitted in the uplink by the UE as a message/signal Y received by the base station.

Embodiments of the present disclosure can be realized in any of various forms. For example, in some embodiments, the present subject matter can be realized as a computer-implemented method, a computer-readable memory medium, or a computer system. In other embodiments, the present subject matter can be realized using one or more custom-designed hardware devices such as ASICs. In other embodiments, the present subject matter can be realized using one or more programmable hardware elements such as FPGAs.

In some embodiments, a non-transitory computer-readable memory medium (e.g., a non-transitory memory element) can be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) can be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
receiving, on a first component carrier (CC), a radio resource control (RRC) configuration message from a serving base station (BS), wherein the RRC configuration message comprises at least one of multicast and broadcast services (MBS) scheduling information or configuration information;
receiving, on the first CC, a transmission from a MBS BS comprising additional MBS information;
determining, based on the received at least one of MBS scheduling information or configuration information, a collision between a unicast transmission and a broadcast transmission;
transmitting, to the MBS BS, an indication of interest related to MBS;
receiving, on a second CC, a RRC reconfiguration message from the MBS BS, wherein the RRC reconfiguration message comprises at least one of adjusted scheduling information or configuration information corresponding to the unicast transmission;
receiving, from the MBS BS, the broadcast transmission; and
receiving, based at least in part on the at least one of adjusted scheduling information or configuration information, the unicast transmission from the serving BS.

2. The method of claim 1, wherein the indication of interest is reported via dedicated signaling.

3. The method of claim 1, wherein the indication of interest comprises at least one of:
MBS interested information,
user equipment (UE) assistance information,
layer-3 (L3) signaling,
layer-2 (L2) media access control-control element (MAC-CE) signaling, or
layer-1 (L1) signaling.

4. The method of claim 1, wherein the indication of interest comprises transmission duration information regarding at least one of the unicast transmission or broadcast transmission and further including information related to at least one of:
a periodicity,
an offset,
a duration,
a switching time, or
a switching gap.

5. The method of claim 1, wherein the indication of interest comprises frequency information regarding at least one of the unicast transmission or broadcast transmission and further including information related to at least one of:
a frequency location,
a bandwidth, or
a subcarrier spacing.

6. The method of claim 1, wherein the indication of interest comprises scheduling information regarding at least one of the unicast transmission or broadcast transmission and further including information related to at least one of:
a preferred discontinuous reception (DRX) configuration,
a switching time, or
a switching gap.

7. The method of claim 1, wherein the indication of interest comprises frequency information regarding at least one of the unicast transmission or broadcast transmission and further includes information related to a preferred serving cell frequency corresponding to the second CC.

8. The method of claim 1, wherein the indication of interest comprises frequency information regarding at least one of the unicast transmission or broadcast transmission and further includes information related to a preferred bandwidth part (BWP) corresponding to the first CC.

9. The method of claim 1, wherein the indication of interest comprises frequency information regarding at least one of the unicast transmission or broadcast transmission and further includes information related to a preferred exclusion of a frequency location corresponding to a range of physical resource blocks (PRBs) from a configured bandwidth (BW) of the first CC.

10. The method of claim 1, wherein the indication of interest comprises spatial information regarding at least one of the unicast transmission or broadcast transmission and further includes information related to a preferred list of quasi-colocated (QCL) antenna ports of the first CC.

11. The method of claim 1, wherein the indication of interest comprises information regarding the unicast transmission and further includes information related to a preference to deactivate or deconfigure a secondary cell (SCell).

12. The method of claim 1, wherein the indication of interest comprises information regarding at least one of the unicast transmission or broadcast transmission and further includes information related to at least one of a MBS broadcast frequency or bandwidth.

13. A method, comprising:
transmitting, to a user equipment (UE), a capability request comprising multicast and broadcast services (MBS) specific information;
receiving, from the UE, a message comprising at least one of a capability report or MBS interested information;
transmitting, to the UE, a radio resource control (RRC) reconfiguration message, wherein the RRC reconfiguration message comprises at least one of adjusted scheduling information or configuration information corresponding to a unicast transmission; and
transmitting, to the UE, a broadcast transmission using the at least one of adjusted scheduling information or configuration information.

14. The method of claim 13, wherein the capability report comprises at least one of:
one or more band combination parameters, or
one or more feature set combination parameters.

15. The method of claim 14, wherein the MBS interested information comprises at least one of one or more preferred band combinations or one or more preferred feature set combinations.

16. An apparatus, comprising:
a processor configured to, when executing instructions stored in a memory, perform operations comprising:
receiving, from a serving base station (BS), a radio resource control (RRC) configuration message comprising a request for a user equipment (UE) to report multicast and broadcast services (MBS) service information of one or more inter-public land mobility network (inter-PLMN) cells;
receiving, a transmission from a MBS BS comprising configuration information corresponding to an inter-PLMN cell of the one or more inter-PLMN cells;
reporting, in response receiving the request, MBS broadcast information to the serving BS corresponding to the inter-PLMN cell;
receiving, from the MBS BS, signaling on a multicast control channel (MCCH) including a change in a mapping between a temporary mobile group identity (TMGI) and a cell identifier (ID) of the inter-PLMN cell; and
transmitting, to the serving BS, the MBS broadcast information corresponding to the inter-PLMN cell including the change in the mapping between the TMGI and a cell ID of the inter-PLMN cell.

17. The apparatus of claim 16, wherein the reporting of the MBS broadcast information is performed according to at least one of the following modes:
a one-shot report mode corresponding to the UE reporting once,
a periodical report mode corresponding to the UE reporting multiple times based on a configured periodicity or a MCCH modification period, or
a report upon change mode corresponding to the UE reporting one or more times in response to one or more changes in the mapping between the TMGI and the cell ID of the inter-PLMN cell.

18. The apparatus of claim 17, wherein the reporting of the MBS broadcast information is associated with at least one of one or more public land mobility networks (PLMNs) or one or more network identifiers (NIDs).

19. The apparatus of claim 16, wherein the operations further comprise:
receiving an additional transmission comprising one or more system information blocks (SIBs) including information corresponding to at least one of the MCCH or configuration information corresponding to a multicast traffic channel (MTCH).

20. The apparatus of claim 16, further comprising:
a radio operably coupled to the processor.
